(19) United States
(12) Patent Application Publication
(10) Pub. No.: US 2026/0195598 A1
(43) Pub. Date: Jul. 9, 2026

(54) IMAGE-SPECIFIC TUNING OF DIFFUSION MODELS FOR INVERSE PROBLEMS AND CONDITIONAL CONTROL IMAGE GENERATION

(71) Applicant: Regents of the University of Minnesota, Minneapolis, MN (US)

(72) Inventors: Mehmet Akçakaya, Minneapolis, MN (US); Yasar Utku Alçalar, Minneapolis, MN (US)

(21) Appl. No.: 19/444,470

(22) Filed: Jan. 9, 2026

Related U.S. Application Data
(60) Provisional application No. 63/743,541, filed on Jan. 9, 2025.

(51) Int. Cl. G06N 3/088; G06T 5/60

(52) U.S. Cl. CPC G06N 3/088; G06T 5/60; G06T 2207/10088; G06T 2207/20081; G06T 2207/20084

(57) ABSTRACT

A diffusion model that has been trained for solving an inverse problem is tuned by learning data fidelity weights (e.g., log-likelihood weights) for the diffusion model using an unsupervised loss function and a sampling noise schedule. The sampling noise schedule includes irregular timesteps. The tuned diffusion model is stored with the computer system.

### CROSS-REFERENCE TO RELATED APPLICATIONS

This application claims the benefit of U.S. Provisional Patent Application Ser. No. 63/743,541, filed on Jan. 9, 2025, and entitled “IMAGE-SPECIFIC TUNING OF DIFFUSION MODELS FOR INVERSE PROBLEMS AND CONDITIONAL CONTROL IMAGE GENERATION,” which is herein incorporated by reference in its entirety.

### STATEMENT OF FEDERALLY SPONSORED RESEARCH

This invention was made with government support under HL153146, EB032830, and EB027061 awarded by the National Institutes of Health. The government has certain rights in the invention.

### BACKGROUND

Diffusion models have emerged as powerful generative techniques for solving inverse problems. Despite their success in a variety of inverse problems in imaging, these models require many steps to converge, leading to slow inference time. Recently, there has been a trend in diffusion models for employing sophisticated noise schedules that involve more frequent iterations of timesteps at lower noise levels, thereby improving image generation and convergence speed. However, application of these ideas to solving inverse problems with diffusion models remain challenging, as these noise schedules do not perform well when using a fixed schedule for the forward model log-likelihood term weights.

### SUMMARY OF THE DISCLOSURE

It is an aspect of the present disclosure to provide a method for tuning a diffusion model for solving an inverse problem. The method includes accessing a diffusion model with a computer system, where the diffusion model has been trained on training data to solve an inverse problem. The diffusion model is tuned with the computer system by learning data fidelity weights, which in some examples can be log-likelihood weights, for the diffusion model using an unsupervised loss function and a sampling noise schedule. The tuned diffusion model is then stored with the computer system.

According to other aspects of the present disclosure, the method may include one or more of the following features. The unsupervised loss function may include a measurement-consistent loss. Tuning the diffusion model may include fixing a number of diffusion sampling steps and tuning the data fidelity weights end-to-end with the unsupervised loss function. The sampling noise schedule may include irregular time steps. The irregular timesteps of the sampling noise schedule may include heavier denoising steps early in the sampling noise schedule and smaller denoising steps later in the sampling noise schedule.

In some aspects, the sampling noise schedule may include uniformly spaced segments across the sampling noise schedule, wherein each uniformly spaced segment includes a different number of timesteps such that the sampling noise schedule includes the irregular timesteps as a whole. The uniformly spaced segments may include three segments. A first one of the three segments may include 15 time steps, a second one of the three segments may include 10 time steps, and a third one of the three segments may include 5 time steps. The data fidelity weights may be learned at each timestep of the sampling noise schedule.

In some aspects, the sampling noise schedule may implement a deterministic sampling scheme. The deterministic sampling scheme may include a denoising diffusion implicit model (DDIM) that samples from the diffusion model. The diffusion model may include a denoising diffusion probabilistic model (DDPM). The inverse problem may include an image reconstruction task. The inverse problem may include an image deblurring task. The inverse problem may include a super-resolution task. The inverse problem may include an image inpainting task.

In still other aspects, the data fidelity weights may be log-likelihood weights and learning the log-likelihood weights for the diffusion model may include approximating a log-gradient of a prior to reduce memory requirements for the computer system. The log-gradient of the prior may be approximated by approximating a Jacobian using wavelet-based signal processing. The inverse problem may include a magnetic resonance imaging (MRI) reconstruction task. The MRI reconstruction task may include reconstructing an image from undersampled k-space data.

According to some aspects, the unsupervised loss function may include a self-supervised loss function computed on held-out measurements. Tuning the diffusion model may include dividing acquired measurement data into a first disjoint set for data consistency updates and a second disjoint set for supervision, and computing the self-supervised loss function based on a discrepancy between predicted measurements and actual measurements over the second disjoint set. The acquired measurement data may include k-space data, and the first disjoint set and the second disjoint set may include disjoint k-space locations.

In some aspects, tuning the diffusion model may include treating a diffusion sampling process as a fixed unrolled architecture and optimizing timestep-dependent data fidelity weights without modifying an underlying score model of the diffusion model. The timestep-dependent data fidelity weights may be optimized at test time without retraining the diffusion model.

In some other aspects, tuning the diffusion model may include performing data consistency updates using conjugate gradient iterations. The conjugate gradient iterations may be constrained to a Krylov subspace that spans a tangent space of a data manifold at a denoised estimate. Tuning the diffusion model may include iteratively performing, for each timestep of the sampling noise schedule: computing a denoised estimate using a score model prediction; performing a data fidelity update using a timestep-dependent data fidelity weight; and performing a diffusion sampling step to obtain a sample for a next timestep. The denoised estimate may be computed using Tweedie's formula. A first one of the three segments may include 17 time steps, a second one of the three segments may include 5 time steps, and a third one of the three segments may include 3 time steps.

In some aspects, the diffusion model may be a pretrained unconditional diffusion model, and tuning the diffusion model may be performed without retraining the pretrained unconditional diffusion model. The data fidelity weights may include timestep-dependent data fidelity weights that are adaptively tuned based on measurement conditions. The measurement conditions may include a signal-to-noise ratio of acquired measurement data.

According to another aspect of the present disclosure, a method for reconstructing an image from undersampled measurement data is provided. The method includes accessing undersampled measurement data with a computer system. The method further includes accessing a pretrained diffusion model with the computer system. The method further includes dividing the undersampled measurement data into a first subset for data consistency updates and a second subset for fidelity weight optimization. The method further includes reconstructing the image by iteratively performing diffusion sampling steps using an irregular noise schedule, wherein each diffusion sampling step includes: computing a denoised estimate using the pretrained diffusion model; performing a data fidelity update using the first subset and a timestep-dependent data fidelity weight; and performing a diffusion sampling update. The method further includes optimizing each of the timestep-dependent data fidelity weights using a self-supervised loss computed on the second subset. The method further includes outputting the reconstructed image.

According to other aspects of the present disclosure, the method may include one or more of the following features. The undersampled measurement data may include undersampled k-space data from a magnetic resonance imaging acquisition. The undersampled k-space data may be acquired using multi-coil encoding. The data fidelity update may be performed using conjugate gradient iterations. The irregular noise schedule may allocate more sampling steps to low-noise regions where high-frequency details are recovered. The pretrained diffusion model may not be retrained during the reconstructing and optimizing steps. The self-supervised loss may include a normalized discrepancy between predicted measurements and actual measurements over the second subset.

According to still another aspect of the present disclosure, a method for enhancing an image using database-level adapted data fidelity control is provided. The method includes accessing input image data with a computer system. The method further includes computing an input representation from the input image data. The method further includes predicting data fidelity modulation parameters using a trained auxiliary network based on the input representation, wherein the trained auxiliary network has been trained over a database of training samples. The method further includes generating an enhanced image using a pretrained diffusion model and the predicted data fidelity modulation parameters, wherein the pretrained diffusion model remains frozen during image enhancement. The method further includes outputting the enhanced image.

### BRIEF DESCRIPTION OF THE DRAWINGS

FIG. 1A illustrates an example implementation of a zero-shot model for diffusion posterior sampling. The disclosed model takes noise as its input and reconstructs an image with substantially fewer steps than for which the score model is trained. The sampling process is unrolled for a fixed number of steps for arbitrary/irregular noise schedules, alternating between score model sampling (SMS) and likelihood guidance (LG). The zero-shot fine-tuning approach has at least two components: the Hessian of the log prior is approximated using a discrete wavelet transform diagonalization technique, and both this diagonal matrix and the log-likelihood weights are updated during fine-tuning. The fine-tuning is done for a fixed number of epochs, yielding a faster and more robust inverse problem solver.

FIG. 1B shows an example zero-shot adaptive diffusion sampling (ZADS) framework, which treats the diffusion sampling process as an unrolled architecture, in which timestep-dependent data fidelity (DF) weights {ζᵢ} are optimized at test time using SSDU loss. In the illustrated example, the acquired k-space locations Ω are split into two disjoint sets: Θ for data fidelity updates, and Λ held out for fidelity-weight tuning. SMP denotes the score model prediction, i.e., the Tweedie denoised estimate, \hat{x}_{0|τ}_{ᵢ}.

FIGS. 2A and 2B show an example fast sampling scheme that uses uniform jumps across the noise schedule (FIG. 2A) and that uses irregular jumps across the noise schedule (FIG. 2B).

FIG. 3 illustrates representative results of using the methods described in the present disclosure for four distinct noisy inverse problems: Gaussian deblurring, random inpainting, motion deblurring, and super resolution (×4). The images in each column, from left to right, represent the ground truth, measurement, and reconstruction images, respectively.

FIG. 4 shows representative images using various methods for solving Gaussian deblurring, motion deblurring, and super-resolution (×4) tasks. The method described in the present disclosure (ZAPS) qualitatively improves upon each method, including the baseline state-of-the-art DPS.

FIG. 5 shows an illustrative image reconstructed using state-of-the-art methods on solving random (70%) and box (128×128) inpainting tasks. The methods described in the present disclosure improve upon DDRM, while achieving similar performance to ΠGDM and DPS, with subtle improvement shown in the zoomed insets.

FIGS. 6A-6C illustrate reconstructions using ZAPS for super-resolution (×4) task with different total timesteps-epochs combinations for the same NFE=300 (FIG. 6A), loss graphs for each combination (FIG. 6B), and PSNR graphs for each combination (FIG. 6C).

FIGS. 7A-7C illustrate qualitative results for shared and distinct log-likelihood weights for irregular timesteps (FIG. 7A), that distinct ('s respond more adeptly to a sub-optimal initialization and can modify the weights accordingly (FIG. 7B), and that shared (is prone to over-fitting.

FIG. 8 shows an overview of a database-level data fidelity control framework applied for diffusion-based MRI reconstruction. A zero-filled reconstruction obtained from undersampled k-space measurements is used as input to an auxiliary network g_{φ}(⋅), which predicts timestep-dependent data fidelity modulation parameters {ζᵢ}. These parameters are injected into a fixed, pretrained diffusion sampling pipeline composed of score model prediction (SMP), data fidelity (DF), and DDIM updates. The diffusion model remains frozen, while the auxiliary network parameters are optimized using a supervised reconstruction loss computed between the final reconstruction x₀ and the fully sampled reference x_{ref}.

FIG. 9 is a block diagram of an example system for tuning and/or implementing a diffusion model (e.g., a DDPM) to solve an inverse problem for an image enhancement task.

FIG. 10 is a block diagram of example components that can implement the system of FIG. 9.

### DETAILED DESCRIPTION

Described here are systems and methods for training, tuning, and implementing diffusion models for solving inverse problems, such as image deblurring, super-resolution, inpainting, and image reconstruction, among other generative artificial intelligence (AI) and image enhancement tasks. In general, the disclosed systems and methods train or otherwise tune a diffusion model for solving an inverse problem using a process in which weights of the diffusion model are learned (e.g., through an unsupervised learning, self-supervised learning, supervised learning, database-level learning, etc.) while also using an irregular sampling schedule to reduce the computational burden of the tuning process.

Diffusion models are a class of generative models that have become increasingly popular over the recent years for their ability to model complex data distributions, including images. When using diffusion models to solve inverse problems, a Bayesian approach is often used with one term that depends on the data distribution (e.g., the pre-learned diffusion model/prior) and another term that involves data fidelity with measurements (e.g., a log-likelihood term). The tradeoff between these terms is achieved with a weighting parameter. In current approaches, the weighting parameter is hand-tuned empirically over the dataset (e.g., FFHQ, ImageNet, fastMRI) or task (e.g., deblurring, inpainting, image reconstruction, etc.) of interest. The disclosed systems and methods provide an advantage over these previous methods by learning these weighting parameters on a case-by-case basis for each instance, or alternatively by learning to predict these weighting parameters at a database level using an auxiliary network.

It is one aspect of the present disclosure to provide a framework for training, tuning, and/or implementing diffusion models for solving inverse problems in which the number of diffusion sampling steps is fixed in the diffusion models. The weights of the diffusion model are then tuned end-to-end with an unsupervised loss function, a self-supervised loss function, and/or a supervised loss function.

It is another aspect of the present disclosure that when a high number of sampling steps is needed (e.g., >1000) for the diffusion model, an irregular sampling schedule can instead be used to reduce the computational burden of tuning the diffusion model. As a non-limiting example, an irregular sampling schedule can include implementing heavier denoising early on with smaller denoising steps later. This irregular sampling schedule is made possible by way of learning the weights of the diffusion model rather than hand-tuning the weights as is done with existing techniques. Even when performing end-to-end optimization, the total number of sampling steps can be reduced by about 10-fold using the techniques described in the present disclosure.

It is yet another aspect of the present disclosure that when training a diffusion model for solving an inverse problem, additional approximations can be performed to reduce what would otherwise be large memory requirements. Advantageously, this allows enables the training, tuning, and implementation of diffusion models for solving inverse problems with fewer computer resources (e.g., memory).

As a non-limiting example, these aspects of the present disclosure can be implemented by using a zero-shot approximate diffusion posterior sampling (ZAPS) that leverages connections to zero-shot physics-driven deep learning. ZAPS uses a diffusion posterior sampling (DPS) technique and fixes the number of sampling steps. Subsequently, zero-shot training with a physics-guided loss function is used to learn log-likelihood weights, or other data fidelity weights, at each irregular timestep. The Hessian of the logarithm of the prior can additionally be approximated using a diagonalization approach with learnable diagonal entries for computational efficiency. These parameters can be optimized over a fixed number of epochs with a given computational budget.

As another non-limiting example, these aspects of the present disclosure can be implemented by using a zero-shot adaptive diffusion sampling (ZADS) framework that adaptively tunes data fidelity weights across arbitrary diffusion noise schedules at test time without retraining the generative prior. ZADS treats the diffusion sampling process as a fixed unrolled architecture and optimizes timestep-dependent fidelity weights using a self-supervised loss on held-out measurements. ZADS is particularly well-suited for MRI reconstruction applications where the measurement conditions and signal-to-noise ratio (SNR) vary across acquisition settings.

As yet another non-limiting example, these aspects of the present disclosure can be implemented by using a database-level adaptation framework that replaces per-sample or per-slice optimization with a learned auxiliary network. The database-level adaptation framework introduces a lightweight external model, such as a multilayer perceptron (MLP), that predicts data fidelity weights conditioned on problem-specific attributes and diffusion state variables. Instead of tuning fidelity weights on a per-sample basis, the database-level adaptation framework learns to predict them using the lightweight auxiliary network trained at the database level. The auxiliary network takes problem-specific inputs and outputs appropriate data fidelity modulation parameters, while the pretrained diffusion model is kept entirely fixed. This yields a dataset-level adaptation strategy that can be applied directly at inference without any additional optimization.

Diffusion models can be used for image generation tasks, image enhancement tasks, image reconstruction tasks, and the like. The capabilities of diffusion models also extend across various domains, including computer vision, natural language processing, temporal data modeling, and medical imaging. Diffusion models can also be implemented for solving noiseless and noisy inverse problems, owing to their capability to capture complex and high-dimensional distributions. Linear inverse problems utilize a known forward problem, which may be given as:

$$y = {Ax}_{0} + n ,$$

and aim to deduce the underlying signal and/or image x∈ [symbol] ⁿ from measurements y∈ [symbol] ^{m}, where n∈ [symbol] ^{m} is measurement noise. In practical situations, the forward operator A: [symbol] ⁿ→ [symbol] ^{m} is either incomplete or ill-conditioned, necessitating the use of prior information about the signal in these instances. Posterior sampling approaches use diffusion models as generative priors and also incorporate information from both the data distribution and the forward physics model, allowing for sampling from the posterior distribution p(x|y) using the given measurement y. In this context, using Bayes' rule,

$$p ( x \vert y ) = \frac{p ( x ) p ( y \vert x )}{p ( y )} ,$$

allows the following problem-specific score:

$${∇}_{{x}_{t}} log p ( x \vert y ) = {∇}_{{x}_{t}} log p ( x ) + {∇}_{{x}_{t}} log p ( y \vert x ) , \qquad ( 1 ) ;$$

where ∇ₓ_{ₜ} log p(x) is approximated via the learned score model s_{θ}(xₜ,t). Many of these strategies utilize a plug-and-play (PnP) approach, using a pre-trained unconditional diffusion model as a prior and then integrate the forward model during inference to address various inverse problem tasks.

The complexity for these approaches arises in obtaining the latter forward model log-likelihood term in Eqn. (1), which guides the diffusion to a target class. While exact calculation is intractable, several approaches have been proposed to approximate this term. One such approach employs a variational sampler that relies on a combination of a measurement consistency loss and score matching regularization. Alternative methods utilize projections onto the convex measurement subspace after the unconditional update through score model. Although this projection approach improves the consistency between the measurement and the sample, these projections are noted to lead to artifacts such as boundary effects. Subsequent approaches aimed to approximate the log-likelihood term in Eqn. (1) in different ways. Noting the following:

$${p}_{t} ( y \vert {x}_{t} ) = {\int }_{{x}_{0}} p ( {x}_{0} \vert {x}_{t} ) p ( y \vert {x}_{0} ) {dx}_{0} , \qquad ( 2 ) ;$$

DPS uses the posterior mean \hat{x}₀=\hat{x}₀(xₜ)≙ [symbol] [x₀|xₜ]= [symbol] ₓ_{₀}_{~p(x}_{₀}_{|x}_{ₜ}₎[x₀] to approximate p(y|xₜ)= [symbol] ₓ_{₀}_{~p(x}_{₀}_{|x}_{ₜ}₎[p(y|x₀)] as:

$$p ( y \vert {x}_{t} ) = {𝔼}_{{x}_{0} ∼ p ( {x}_{0} \vert {x}_{t} )} [ p ( y \vert {x}_{0} ) ] ≃ p ( y \vert {𝔼}_{{x}_{0} ∼ p ( {x}_{0} \vert {x}_{t} )} [ {x}_{0} ] ) = p ( y \vert {\hat{x}}_{0} ) .$$

Another approach, IIGDM approximates Eqn. (2) as a Gaussian centered around A\hat{x}₀

$${\int }_{{x}_{0}} p ( {x}_{0} \vert {x}_{t} ) p ( y \vert {x}_{0} ) {dx}_{0} ≃ 𝒩 ( A {\hat{x}}_{0} , {r}_{t}^{2} {AA}^{T} + {σ}_{y}^{2} I ) , \qquad ( 3 ) ;$$

and uses it for guidance. In these works, log-likelihood weights (or gradient step sizes), {ζₜ} are introduced to further control the reconstruction as:

$${∇}_{{x}_{t}} log p ( x \vert y ) = {∇}_{{x}_{t}} log p ( x ) + {ζ}_{t} {∇}_{{x}_{t}} log p ( y \vert x ) . \qquad ( 4 ) .$$

While DPS demonstrates high performance in various inverse problem tasks, it suffers from the drawback of requiring a large number of sampling steps, resulting in prolonged reconstruction time. ΠGDM accelerates this process by adopting a regular (e.g., linear) jumps approach across the schedule. However, utilizing more complex schedules where the jumps are irregular introduces a challenge, as it requires distinct log-likelihood weights for each timestep. Heuristic adjustment of these weights is difficult and frequently leads to undesirable outcomes.

The disclosed systems and methods overcome these drawbacks by using an irregular sampling schedule to realize improved computational efficiency and by learning the log-likelihood weights, or other data fidelity weights, for each timestep. As a non-limiting example, zero-shot/test-time self-supervised models are adapted to learn the log-likelihood weights, or other data fidelity weights, for a fixed number of sampling steps and the weights are then fine-tuned over a few epochs. Fine-tuning DPS entails saving computational graphs for each unroll, which can lead to memory issues and slow backpropagation. Thus, the disclosed systems and methods can also approximate the Hessian of the data probability using a wavelet-based diagonalization strategy, and can learn these diagonal values as well.

It is thus one aspect of the present disclosure to provide a ZAPS framework that leverages zero-shot learning for dynamic automated hyperparameter tuning in the inference phase to improve the solution of noisy inverse problems via diffusion models. This method fortifies the robustness of the sampling process, thereby improving the performance in sampling outcomes. The disclosed methods can learn the log-likelihood weights, or other data fidelity weights, for solving inverse problems via diffusion models by using a measurement-consistent loss when the sampling noise schedule includes irregular jumps across timesteps. The learning-based approach described herein is generally applicable to any data fidelity weighting parameters that control the balance between data fidelity terms in the diffusion sampling process for inverse problems.

It is another aspect of the present disclosure to provide a well-designed approximation for the Hessian of the logarithm of the prior, enabling a computationally efficient and trainable posterior computation.

In medical imaging, particularly MRI, inverse problems arise from the need to accelerate acquisition by sampling only a subset of k-space. The inverse problem in MRI reconstruction can be formulated as:

$$arg {min}_{x} {‖ {y}_{Ω} - {E}_{Ω} x ‖}_{2}^{2} + ℛ ( x ) ,$$

where Ω is the k-space sampling pattern, and E_{Ω} is the associated multi-coil encoding operator incorporating Fourier undersampling and coil sensitivities. The first quadratic term enforces fidelity with measured data, and [symbol] ( ) serves as a regularizer encoding prior information about the image.

Physics-driven deep learning (PD-DL) methods have addressed MRI reconstruction using unrolled optimization networks to map undersampled to fully sampled data. However, these models often fail to generalize across acquisition settings due to their reliance on fixed forward models shaped by vendor, hardware, and protocol differences. Diffusion-based reconstruction offers a compelling alternative by decoupling the prior from the measurement process. This allows the same pretrained prior to adapt flexibly at inference to various forward operators, improving robustness across sampling patterns and scanner configurations.

Despite this flexibility, the performance of diffusion-based methods is still sensitive to data fidelity weights, which are often hand-tuned heuristically for varying noise levels and measurement SNR. This sensitivity is especially problematic in regimes with very low numbers of function evaluations (NFEs), where irregular schedules are required to preserve fine details, but the corresponding fidelity weights are particularly difficult to hand-tune due to their non-uniform behavior across timesteps.

One example PD-DL approach tackles the MRI reconstruction problem by unrolling traditional iterative algorithms into a fixed number of learnable stages and training the network end-to-end to simultaneously learn the proximal operator defined by [symbol] (⋅) and tune data fidelity weights. In supervised setups, the training objective minimizes the difference between the network output and the fully-sampled reference image.

To overcome the difficulty of acquiring fully-sampled data in practical MRI settings, self-supervision via data undersampling (SSDU) can be used to divide the acquired k-space into two disjoint sets: Θ for data consistency and network input, and A for supervision. The model is then trained to minimize the discrepancy between predicted and actual measurements over Λ, enabling learning directly from undersampled data:

$${min}_{θ} 𝔼 [ ℒ ( {y}_{Λ} , {E}_{Λ} ( f ( {y}_{Θ} , {E}_{Θ} ; θ ) ) ) ] .$$

This SSDU-based approach enables self-supervised learning for MRI reconstruction without requiring fully-sampled reference data, which is particularly advantageous in clinical settings where acquiring fully-sampled data may be impractical or impossible.

During training, diffusion models add Gaussian noise to an image with a fixed increasing variance schedule, such as linear or exponential, β₁, β₂, . . . , δ_{T}, until pure noise is obtained. The diffusion model then learns a reverse diffusion process, where a neural network is trained to gradually remove noise and reconstruct the original image. Let x₀~p_{data}(x) represent samples from a data distribution. Denoising diffusion probabilistic models (DDPMs) learn the following reverse process:

$${p}_{θ} ( {x}_{0} ) = \int {p}_{θ} ( {x}_{T} ) {\prod }_{t = 1}^{T} {p ( t )}_{θ} ( {x}_{t - 1} \vert {x}_{t} ) {dx}_{1 : T} . \qquad ( 5 ) ;$$

Here, X_{{1:T}}∈ [symbol] ^{d} are noisy latent variables and by taking αₜ=1−βₜ and

$${\overline{α}}_{t} = {\sum }_{s = 1}^{t} {α}_{s} ,$$

a Markovian forward process can be written as:

$$q ( {x}_{t} \vert {x}_{0} ) = 𝒩 ( {x}_{t} \vert \sqrt{{\overline{α}}_{t}} {x}_{0} , ( 1 - {\overline{α}}_{t} ) I ) . \qquad ( 6 ) .$$

By using reparameterization and Eqn. (6), xₜ can be sampled as:

$${x}_{t} ( {x}_{0} , ϵ ) = \sqrt{{\overline{α}}_{t}} {x}_{0} + \sqrt{1 - {\overline{α}}_{t}} ϵ where ϵ ∼ 𝒩 ( ϵ ; 0 , I ) , \qquad ( 7 ) ;$$

and consequently, the training can be performed on the following lower bound:

$${L}_{t} ( θ ) = {𝔼}_{t , {x}_{0} , ϵ} {‖ ϵ - {ϵ}_{θ} ( {x}_{t} ( {x}_{0} , ϵ ) , t ) ‖}_{2}^{2} . \qquad ( 8 ) .$$

Moreover, it can be demonstrated that epsilon matching given in Eqn. (8) is analogous to the denoising score matching (DSM) objective up to a constant:

$${min}_{θ} {𝔼}_{{x}_{t} , {x}_{0} , ϵ} {‖ {s}_{θ} ( {x}_{t} , t ) - {∇}_{{x}_{t}} log q ( {x}_{t} \vert {x}_{0} ) ‖}_{2}^{2} , \qquad ( 9 ) ;$$

in which

$${s}_{θ} ( {x}_{t} , t ) = - \frac{{ϵ}_{θ} ( {x}_{t} , t )}{\sqrt{1 - {\overline{α}}_{t}}} .$$

Using Tweedie's formula and Eqn. (7), the posterior mean for p(x₀|xₜ) can be found as:

$${\hat{x}}_{0} = \frac{1}{\sqrt{{\overline{α}}_{t}}} ( {x}_{t} + ( 1 - {\overline{α}}_{t} ) {s}_{θ} ( {x}_{t} , t ) ) . \qquad ( 10 ) .$$

Sampling xₜ₊₁ from p(xₜ₊₁|xₜ) can be done using ancestral sampling by iteratively computing:

$${x}_{t - 1} = \frac{1}{\sqrt{{α}_{t}}} ( {x}_{t - 1} - \frac{1 - {α}_{t}}{\sqrt{1 - {\overline{α}}_{t}}} {ϵ}_{θ} ( {x}_{t} , t ) ) + {σ}_{t} z , \qquad ( 11 ) ;$$

where z~ [symbol] (0,I) and

$${σ}_{t}^{2} = {\tilde{β}}_{t} = \frac{1 - {\overline{α}}_{t - 1}}{1 - {\overline{α}}_{t}} {β}_{t} .$$

For complex-valued data, such as MRI data, the initial sample can be drawn from a complex normal distribution X_{T}~ [symbol] (0,I), where [symbol] denotes the complex normal distribution. This enables the diffusion model to handle the complex-valued nature of k-space data and reconstructed images.

When solving inverse problems via diffusion models, one challenge is to find an approximation to the log-likelihood term, ∇ₓ_{ₜ} log p(y|x), as discussed above. In some instances, this can be done by using a denoising diffusion restoration models (DDRMs) algorithm, which utilizes a spectral domain methodology, allowing the incorporation of noise from the measurement domain into the spectral domain through singular value decomposition (SVD). However, the application of SVD is computationally expensive. A Manifold Constrained Gradient (MCG) method applies projections after the MCG correction as:

$${x}_{t - 1}^{′} = f ( {x}_{t} , {s}_{θ} ) - ζ {∇}_{{x}_{t}} {‖ K ( y - A {\hat{x}}_{0} ) ‖}_{2}^{2} + g ( {x}_{t} ) z , z ∼ 𝒩 ( 0 , I ) , \qquad ( 12 ) ;$$

$${x}_{t - 1} = {Hx}_{t - 1} + b , \qquad ( 13 ) ;$$

where ζ and H are dependent on noise covariance. The MCG update of Eqn. (12) projects estimates onto the measurement subspace, thus they may fall off from the data manifold. Thus, DPS proposes to update without projections as:

$${x}_{t - 1} = {x}_{t - 1}^{′} - {ζ}_{i} {∇}_{{x}_{t}} {‖ y - A {\hat{x}}_{0} ‖}_{2}^{2} , \qquad ( 14 ) .$$

Note that Eqn. (14) is equivalent to Eqn. (12) when K=I, and it reduces to the following when the forward operator is linear:

$${x}_{t - 1} = {x}_{t - 1}^{′} - \frac{\partial {\hat{x}}_{0}}{\partial {x}_{t}} {A}^{T} ( y - A {\hat{x}}_{0} ) . \qquad ( 15 )$$

ΠGDM, on the other hand, utilizes a Gaussian centered around \hat{x}₀ that is defined in Eqn. (10) to obtain the following score approximation:

$${∇}_{{x}_{t}} log {p}_{t} ( y \vert {x}_{t} ) ≃ \frac{\partial {\hat{x}}_{0}}{\partial {x}_{t}} {{A}^{T} ( {r}_{t}^{2} {AA}^{T} + {σ}_{y}^{2} I )}^{- 1} ( y - A {\hat{x}}_{0} ) . \qquad ( 16 ) .$$

In cases where there is no measurement noise (σ_{y}=0), Eqn. (16) simplifies to:

$${∇}_{{x}_{t}} log {p}_{t} ( y \vert {x}_{t} ) ≃ {r}_{t}^{- 2} \frac{\partial {\hat{x}}_{0}}{\partial {x}_{t}} {A}^{†} ( y - A {\hat{x}}_{0} ) ; \qquad ( 17 )$$

where A† denotes the Moore-Penrose pseudoinverse of A. Using the Woodbury matrix identity, Eqn. (16) can also be simplified to:

$${∇}_{{x}_{t}} log p ( y \vert {x}_{t} ) ≃ \frac{\partial {\hat{x}}_{0}}{\partial {x}_{t}} {( {A}^{T} A + η I )}^{- 1} {A}^{T} ( y - A {\hat{x}}_{0} ) , where η = \frac{{σ}_{y}^{2}}{{r}_{t}^{2}} . \qquad ( 18 ) .$$

From Eqn. (18), the similarity between DPS and IIGDM updates can be seen, with the (A^{T}A+ηI)⁻¹ term being the difference. Note the DPS update in Eqn. (14) works with non-linear operators, while IIGDM's update does not rely on the differentiability of the forward operator, as long as a pseudo-inverse-like operation can be derived.

Building on DPS, decomposed diffusion sampling (DDS) proposes a geometry-aware refinement strategy that avoids direct gradient updates by leveraging linear solvers. In DDS, it is assumed that the clean data manifold [symbol] is locally affine or well-approximated by its tangent space [symbol] at the denoised estimate \hat{x}_{0|t}. Under this assumption, the Jacobian ∂\hat{x}_{0|t}/∂xₜ reduces to [symbol] /α̅ₜ, yielding:

$${\hat{x}}_{0 \vert t} - ζ \cdot {∇}_{{x}_{t}} ℓ ( {\hat{x}}_{0 \vert t} ) = {𝒫}_{ℳ} ( {\hat{x}}_{0 \vert t} - {ζ}^{′} {∇}_{{\hat{x}}_{0 \vert t}} ℓ ( {\hat{x}}_{0 \vert t} ) ) ,$$

where [symbol] denotes the projection operator onto the tangent space. This insight motivates replacing the single projected step with classical conjugate gradient (CG) steps constrained to the Krylov subspace. Since the Krylov subspace spans the tangent space of [symbol] at \hat{x}_{0|t}, DDS performs an M-step CG update within this subspace to obtain the refined estimate.

In the DDS framework, the refined denoised estimate is obtained through CG iterations as:

$${\hat{x}}_{0 \vert t}^{′} = CG ( {E}_{Ω}^{H} {E}_{Ω} + ζ \cdot I , {E}_{Ω}^{H} y + ζ \cdot {\hat{x}}_{0 \vert t} , {\hat{x}}_{0 \vert t} , M ) ,$$

where ζ is the data fidelity weight selected through heuristic tuning, E_{Ω} is the multi-coil encoding operator,

$${E}_{Ω}^{H}$$

is its Hermitian transpose, and M is the number of CG iterations. The final sample at timestep t−1 is computed as:

$${x}_{t - 1} = \sqrt{{\overline{α}}_{t - 1}} {\hat{x}}_{0 \vert t}^{′} + {\hat{ω}}_{t} .$$

The CG-based approach can provide a more stable and efficient method for enforcing data consistency compared to direct gradient updates, particularly for MRI reconstruction where the forward operator involves multi-coil encoding and Fourier transforms.

Diffusion models typically utilize well-defined fixed noise schedules, with examples including linear or exponential schedules. It is an aspect of the present disclosure to sweep across these schedules and take samples in irregular timesteps for unconditional image generation. The idea behind this strategy hinges on more frequent sampling for lower noise levels, making it possible to use considerably fewer sampling steps.

Most of the aforementioned techniques that solve inverse problems via diffusion models used the same number of steps that the unconditional diffusion model was trained for. Nonetheless, there has been a notable trend favoring shorter schedules characterized by linear jumps for inverse problems, where the log-likelihood weights are hand-tuned by trial-and-error when using reduced number of steps. While these approaches have proven effective, they still require a large number of sampling steps and/or heuristic tuning of the log-likelihood weights, {ζₜ} in Eqn. (4) to achieve good performance. The former issue leads to lengthy and potentially impractical computational times, while the latter issue results in generalizability difficulties for adoption at different measurement noise levels and variations in the measurement operators.

An irregular jump strategy has not garnered significant attention for inverse problems, mainly due to the impracticality of empirically tuning the log-likelihood weights. Thus, the disclosed systems and methods, which automatically select and adjust log-likelihood weights based on the provided measurements for arbitrary noise schedules, instead of requiring manual tuning, can significantly improve upon these prior techniques to enable improving robustness and image quality.

The disclosed systems and methods provide a robust automated approach for setting the log-likelihood weights for each timestep for arbitrary noise sampling schedules. This allows for a stable reconstruction for different sweeps across noise schedules. Furthermore, the weights themselves are image-specific, which improves the performance compared to former approaches. As a non-limiting example, for estimating the likelihood in Eqn. (1) the following update in DPS can be used:

$${∇}_{{x}_{t}} log p ( y \vert {x}_{t} ) ≃ {∇}_{{x}_{t}} {‖ y - A {\hat{x}}_{0} ‖}_{2}^{2} = - \frac{\partial {\hat{x}}_{0}}{\partial {x}_{t}} {A}^{T} ( y - A {\hat{x}}_{0} ) , \qquad ( 19 ) ;$$

although as noted before the update in ΠGDM can similarly be used. Recalling the definition of \hat{x}₀ in Eqn. (10), the following expression can be constructed:

$$\frac{\partial {\hat{x}}_{0}}{\partial {x}_{t}} = \frac{1}{\sqrt{{\overline{α}}_{t}}} ( I + ( 1 - {\overline{α}}_{t} ) \frac{\partial {s}_{θ} ( {x}_{t} , t )}{\partial {x}_{t}} ) . \qquad ( 20 ) .$$

Thus, ignoring the calculation and storage of the matrix

$$\frac{\partial {s}_{θ} ( {x}_{t} , t )}{\partial {x}_{t}}$$

for now, the log-likelihood weights {ζₜ} can be fine-tuned in:

$${∇}_{{x}_{t}} log p ( x ) + {ζ}_{t} \frac{1}{\sqrt{{\overline{α}}_{t}}} ( I + ( 1 - {\overline{α}}_{t} ) \frac{\partial {s}_{θ} ( {x}_{t} , t )}{\partial {x}_{t}} ) {A}^{T} ( y - A {\hat{x}}_{0} ) . \qquad ( 21 ) .$$

As an example, this can be done by following the concept of algorithm unrolling in physics-driven deep learning by fixing the number of sampling steps, T. Then, the posterior sampling process can be described as alternating between DDPM sampling using the pre-trained unconditional score model, followed by the log-likelihood term guidance in Eqn. (21) for T steps. This unrolled network is fine-tuned end-to-end, where the only updates are made to {ζₜ} and no fine-tuning is performed on the unconditional score function, s_{θ}(xₜ,t). This also alleviates the need for backpropagation across the score function network, leading to further savings in computational time. The fine-tuning is performed using a physics-inspired loss function that evaluates the consistency of the final estimate and the measurements:

$$ℒ ( y , {\hat{x}}_{0} ) = {‖ y - {Ax}_{0} ‖}_{2}^{2} .$$

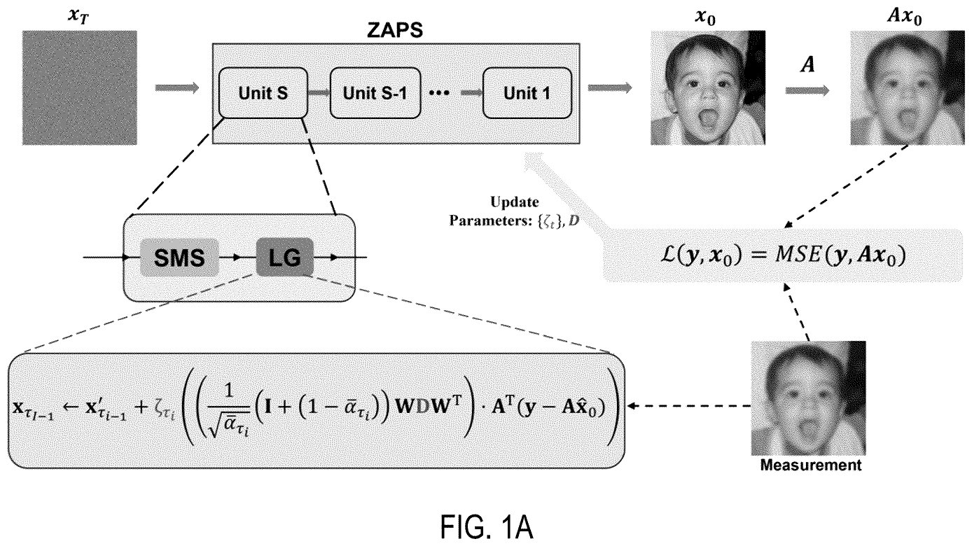

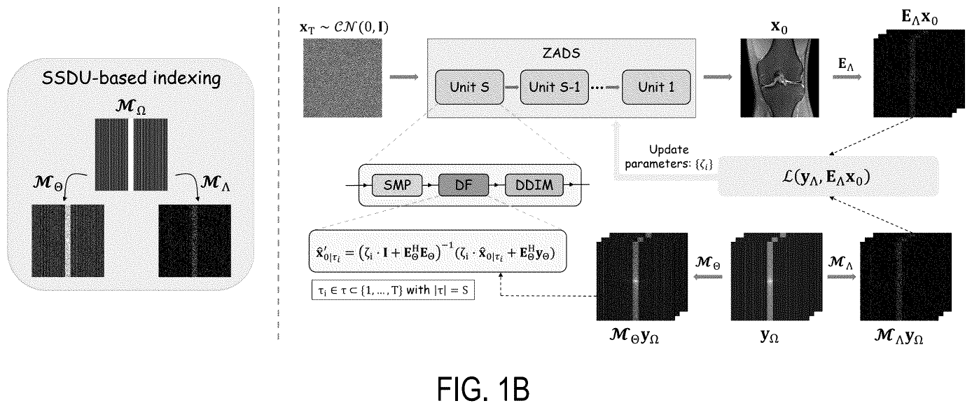

A high-level description of this method is illustrated in FIG. 1A.

While recent diffusion-based solvers have improved data-consistent diffusion sampling, they still depend on fixed noise schedules and manually selected fidelity weights. This reliance may result in suboptimal reconstructions, since the optimal weighting often depends on the measurement SNR or noise level, which varies across MRI acquisition settings. Furthermore, this limits the use of irregular noise schedules, as heuristically choosing the fidelity weights can become impractical due to each timestep affecting the output differently.

To address these limitations, the disclosed systems and methods provide a ZADS framework. The ZADS framework provides a unified approach that adaptively sets timestep-dependent data fidelity weights for each timestep to better align the posterior with the observed measurements, without retraining the unconditional diffusion model. ZADS treats the diffusion sampling procedure in DDS as a fixed unrolled process and optimizes only the fidelity weights across timesteps, without modifying the underlying score model. Unlike previous approaches that rely on fixed heuristics, ZADS learns these weights at test time by minimizing a self-supervised loss derived from held-out measurements.

As a non-limiting example, ZADS can adopt a strategy inspired by SSDU, in which the acquired k-space is split into disjoint sets: one subset Θ is used to enforce data consistency during CG, while the other subset A is held out for fidelity-weight optimization. For an arbitrary noise schedule τ⊆{1, . . . , T}, with S=|τ|<<T, ZADS obtains the refined denoised estimate through:

$${\hat{x}}_{0 \vert {τ}_{i}}^{′} = CG ( {E}_{Θ}^{H} {E}_{Θ} + {ζ}_{i} \cdot I , {E}_{Θ}^{H} y + {ζ}_{i} \cdot {\hat{x}}_{0 \vert {τ}_{i}} , {\hat{x}}_{0 \vert {τ}_{i}} , M ) .$$

After producing the final output x₀ using only a few NFEs, a physics-driven loss is computed on the held-out A samples using a normalized L1 and L2 loss formulation:

$$ℒ ( {y}_{Λ} , {E}_{Λ} {x}_{0} ) = \frac{{‖ {y}_{Λ} - {E}_{Λ} {x}_{0} ‖}_{1}}{{‖ {y}_{Λ} ‖}_{1}} + \frac{{‖ {y}_{Λ} - {E}_{Λ} {x}_{0} ‖}_{2}}{{‖ {y}_{Λ} ‖}_{2}} .$$

This SSDU-based loss function enables self-supervised optimization of the fidelity weights without requiring fully-sampled reference data, making ZADS particularly suitable for clinical MRI applications where fully-sampled data may not be available. Additionally, by avoiding retraining the diffusion model, ZADS leverages the strengths of the diffusion prior across different SNRs, while providing automatic adaptability for data fidelity. This further makes ZADS particularly well-suited for MRI reconstruction applications where the measurement conditions and noise levels vary across acquisition settings.

An example implementation of the ZADS algorithm can be observed as follows:

Algorithm: Zero-shot Adaptive Diffusion Sampling (ZADS)

| $Require : {ϵ}_{{θ}^{*}} , T , {\{ {α}_{t} \}}_{t = 1}^{T} , η , {E}_{Ω} , {y}_{Ω} , M$ | | |
|---|---|---|
| 1: | XT ~ [symbol] (0, I) | |
| 2: | [symbol] Selection of an irregular schedule | |
| 3: | τ ⊂ {1, ... , T} extending over a length of S < T | |
| 4: | Get {E_{(Θ,Λ}}, y_{{Θ,Λ}}} | [symbol] SSDU-based index splitting |

| | |
|---|---|
| 5: | for epoch in epochs do |
| 6: | for i = S, ... , 1 do |
| 7: | \hat{ϵ}_{τ}_{ᵢ} ← ϵ_{θ*} (X_{τ}_{ᵢ}, τᵢ) |
| 8: | [symbol] Score model prediction (Tweedie denoising) |
| 9: | ${\hat{x}}_{0 \vert {τ}_{i}} ← ( {x}_{{τ}_{i}} - \sqrt{1 - {\overline{α}}_{{τ}_{i}}} {\hat{ϵ}}_{{τ}_{i}} ) / \sqrt{{\overline{α}}_{{τ}_{i}}}$ |
| 10: | [symbol] Data consistency |
| 11: | ${E}_{CG} ← {ζ}_{i} \cdot I + {E}_{Θ}^{H} {E}_{Θ}$ |
| 12: | ${y}_{CG} ← {ζ}_{i} \cdot {\hat{x}}_{0 \vert {τ}_{i}} + {E}_{Θ}^{H} {y}_{Θ}$ |
| 13: | ${\hat{x}}_{0 \vert {τ}_{i}}^{′} ← CG ( {E}_{CG} , {y}_{CG} , {\hat{x}}_{0 \vert {τ}_{i}} , M )$ |
| 14: | [symbol] DDIM sampling |
| 15: | z ~ [symbol] (0, I)ifτᵢ > 1, else z = 0 |
| 16: | ${σ}_{{τ}_{i}} ← η \sqrt{\frac{( 1 - {\overline{α}}_{{τ}_{i - 1}} )}{( 1 - {\overline{α}}_{{τ}_{i}} )} ( 1 - \frac{{\overline{α}}_{{τ}_{i}}}{{\overline{α}}_{{τ}_{i - 1}}} )}$ |
| 17: | ${x}_{{τ}_{i - 1}} ← \sqrt{{\overline{α}}_{{τ}_{i - 1}}} {\hat{x}}_{0 \vert {τ}_{i}}^{′} + \sqrt{1 - {\overline{α}}_{{τ}_{i - 1}} - {σ}_{{τ}_{i}}^{2}} {\hat{ϵ}}_{{τ}_{i}} + {σ}_{{τ}_{i}} z$ |
| 18: | end for |
| 19: | Update network parameters {ζᵢ} via [symbol] (y_{Λ}, E_{Λ}x₀) |
| 20: | end for |
| 21: | return x₀ |

A high-level description of the ZADS method is illustrated in FIG. 1B.

While the ZADS framework described above optimizes fidelity weights at test time for individual samples, an alternative approach involves learning to predict these weights using a lightweight auxiliary network trained at the database level. This database-level adaptation strategy replaces per-sample or per-slice optimization with a learned auxiliary network that predicts data fidelity modulation parameters conditioned on problem-specific attributes and diffusion state variables.

In this approach, an auxiliary network, such as an MLP, is introduced and parameterized by learnable parameters. The auxiliary network takes as input a conditioning image that captures relevant characteristics of the inverse problem. In the context of MRI reconstruction, the conditioning image may be a zero-filled reconstruction obtained by applying the adjoint MRI operator to the undersampled k-space measurements, which implicitly captures the undersampling pattern, acceleration factor, coil geometry, and effective signal-to-noise ratio. For other image enhancement tasks, the conditioning image may take different forms depending on the nature of the inverse problem. For example, in image deblurring tasks, the conditioning image may be the blurred input image itself. In super-resolution tasks, the conditioning image may be the low-resolution input image or an upsampled version thereof. In image inpainting tasks, the conditioning image may be the masked or corrupted input image with missing regions. In image denoising tasks, the conditioning image may be the noisy input image. More generally, the conditioning image may be any degraded or corrupted version of the target image that is available as input to the inverse problem, or any preliminary estimate or reconstruction derived from the available measurements or observations. Given a conditioning image, such as a zero-filled reconstruction

$${x}_{ZF} = {E}_{Ω}^{H} {y}_{Ω}$$

for the MRI reconstruction context, the auxiliary network uses this image as its conditioning input and outputs a set of timestep-dependent data fidelity modulation parameters {ζ} that control the strength of data fidelity enforcement at different stages of the diffusion sampling process.

The predicted parameters are injected directly into the diffusion-based image enhancement or reconstruction pipeline, replacing manually selected or iteratively optimized fidelity settings. Importantly, the generative diffusion model remains entirely frozen throughout both training and inference, ensuring that the learned adaptation operates solely through the auxiliary network while preserving the pretrained image prior. This design preserves the forward-operator agnostic and zero-retraining advantages of diffusion priors, and is applicable to various image enhancement and reconstruction tasks, such as those described above.

Training is performed over a database of paired measurement data and reference images. For image reconstruction tasks such as MRI reconstruction, the measurement data may include undersampled k-space data, and a zero-filled reconstruction is first computed and used as input to the auxiliary network. For other image enhancement tasks such as deblurring, super-resolution, or inpainting, the measurement data may include degraded images (e.g., blurred images, low-resolution images, or images with missing regions), and the degraded image itself or a preliminary estimate derived therefrom is used as input to the auxiliary network. The network predicts a set of data fidelity modulation parameters, which are then injected into a fixed diffusion-based image enhancement pipeline to produce an enhanced or reconstructed image. A supervised loss is computed by comparing the output image to the fully sampled reference or ground truth image, and gradients are backpropagated exclusively through the auxiliary network, while all parameters of the pretrained diffusion model remain frozen. The auxiliary network parameters are learned by minimizing the empirical risk over the training database. Alternatively, a self-supervised loss can also be used if reference images are unavailable, such as by using measurement-consistent losses that enforce agreement with held-out portions of the measurement data.

By decoupling learning from the generative prior, the auxiliary network learns dataset-level data fidelity control strategies that generalize across subjects, sampling patterns, and noise conditions, while preserving the pretrained diffusion model as a fixed image prior. At inference time, the trained auxiliary network predicts the required modulation parameters in a single forward pass from the zero-filled or other conditioning input. These parameters are directly applied within the diffusion-based reconstruction process, eliminating the need for per-slice optimization or heuristic tuning and enabling fast and adaptive MRI reconstruction or other image enhancement tasks with minimal computational overhead.

Implementing the update in Eqn. (21) poses various challenges, since one needs to backpropagate through the unrolled network to update {ζₜ}. However, the computational graphs that are created when calculating the Jacobian term in Eqn. (21) also need to be retained before making the final backpropagation. Storing the graphs from each timestep can become a memory concern, especially when the number of sampling steps increases. Also, backpropagating through multiple graphs at the end just to update the log-likelihood weights is time-inefficient and causes prolonged sampling times. Hence, in some examples the systems and methods described in the present disclosure can approximate the Jacobian using wavelet-based signal processing techniques, and this approximation can be learned to improve the overall outcome. Noting that s_{θ}(×ₜ,t) in Eqn. (20) is an approximation of the log-gradient of the true prior p(×), the following expression can be constructed:

$$\frac{\partial {\hat{x}}_{0}}{\partial {x}_{t}} = \frac{1}{\sqrt{{\overline{α}}_{t}}} ( I + ( 1 - {\overline{α}}_{t} ) \frac{{\partial }^{2} log {p}_{t} ( {x}_{t} )}{\partial {x}_{t}^{2}} ) . \qquad ( 22 ) .$$

To make a backpropagation to update these weights, the Hessian matrix

$$\frac{{\partial }^{2} log {p}_{t} ( {x}_{t} )}{\partial {x}_{t}^{2}}$$

given in Eqn. (22) can be calculated. This matrix is the negative of the observed Fisher information matrix, whose expected value is the Fisher information matrix. In the limit, the Hessian matrix also approximates the inverse covariance matrix of the maximum likelihood estimator. Furthermore, under mild assumptions about continuity of the prior, the observed Fisher information matrix is symmetric. Thus, an appropriate decorrelating unitary matrix can be used to diagonalize this matrix. While finding the desired unitary matrix can be as time-consuming as calculating this Hessian, several pre-determined unitary transforms can be used for decorrelation. For example, unitary wavelet transforms for Wiener filtering can be used, where these transforms were utilized for their tendency to decorrelate data, such as to approximate the Karhunen-Loeve transform. The disclosed systems and methods can follow this approach and aim to approximately diagonalize the Hessian of the log prior,

$$\frac{{\partial }^{2} log {p}_{t} ( {x}_{t} )}{\partial {x}_{t}^{2}}$$

using fixed discrete orthogonal wavelet transforms:

$$\frac{{\partial }^{2} log {p}_{t} ( {x}_{t} )}{\partial {x}_{t}^{2}} ≃ {WDW}^{T} , \qquad ( 23 ) ;$$

where W is an orthogonal discrete wavelet transform (DWT). By making this approximation, backpropagation through the score model can also be avoided, and only the diagonal values in the D matrix need to be learned. An example implementation of this algorithm to sample from pure noise with fine-tuning can be observed as follows:

Algorithm: Zero-shot Approximate Diffusion Posterior Sampling (ZAPS)

$Require : T , y , {\{ {\tilde{σ}}_{i} \}}_{i = 1}^{T} , orthogonal DWT ( W )$

| 1: | x_{T} ~ [symbol] (0, I) | |
|---|---|---|
| 2: | τ ⊂ {1, ... , T} extending over a length of S < T | |
| 3: | for epoch in range(epochs) do | |
| 4: | for i = S, ... , 1 do | |
| 5: | ŝ_{τ}_{ᵢ}; < s_{θ}(x_{τ}_{ᵢ}, τᵢ) | [symbol] Score computation |

| | |
|---|---|
| 6: | ${\hat{x}}_{0} ← \frac{1}{\sqrt{{\overline{α}}_{{τ}_{i}}}} ( {x}_{{τ}_{i}} + ( 1 - {\overline{α}}_{{τ}_{i}} ) \hat{s} ) \qquad \text{?} Tweedie denoising$ |
| 7: | Z ~ [symbol] (0, I) if τᵢ > 1, else z = 0 |
| 8: | ${x}_{{τ}_{i - 1}}^{′} ← \frac{\sqrt{{α}_{{τ}_{i}}} ( 1 - {\overline{α}}_{{τ}_{i - 1}} )}{1 - {\overline{α}}_{{τ}_{i}}} {x}_{{τ}_{i}} + \frac{\sqrt{{\overline{α}}_{{τ}_{i - 1}}} {β}_{{τ}_{i}}}{1 - {\overline{α}}_{{τ}_{i}}} {\hat{x}}_{0} + {\tilde{σ}}_{{τ}_{i}} z$ |
| 9: | ${x}_{{τ}_{i - 1}} ← {x}_{{τ}_{i - 1}}^{′} + {ζ}_{{τ}_{i}} ( ( \frac{1}{\sqrt{{\overline{α}}_{{τ}_{i}}}} ( I + ( 1 - {\overline{α}}_{{τ}_{i}} ) ) {WDW}^{T} ) \cdot {A}^{T} ( y - A {\hat{x}}_{0} ) )$ |
| 10: | end for |
| 11: | Update network parameters {ζᵢ} and D |
| 12: | end for |
| 13: | return x₀ |

In an example implementation, values for the learnable parameters {ζₜ} and D can be initialized uniformly across steps and diagonals, respectively. As one non-limiting example, for {ζₜ} initialization in Gaussian and motion blur, 0.2 can be used. For random inpainting and super-resolution, 0.1 can be used. For all inverse problem tasks, diagonals of D can be initialized to 0.2.

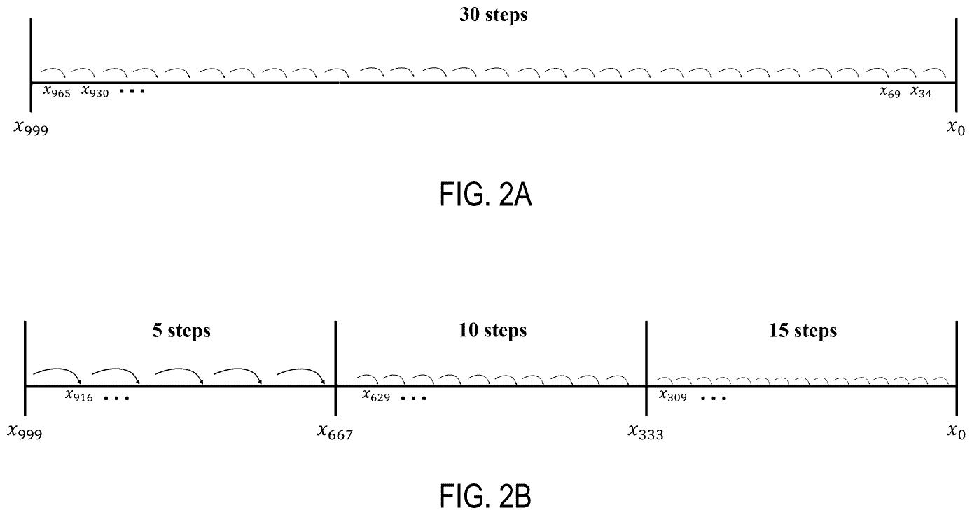

The sampling process for diffusion models can be accelerated via skipping some steps in the diffusion process, as described above. A straightforward approach is to use uniformly spaced jumps across the noise schedule, as illustrated in FIG. 2A, where the sampling path is uniformly spaced out by the selected number of steps in a regular manner. In some examples, a “15,10,5” schedule, which is pictorially depicted in FIG. 2B, can be used. This schedule amounts to partitioning the total number of steps used in training into three parts and taking uniformly spaced 5, 10, and 15 samples from the respective segments, leading to increased sampling frequency at the lower noise levels. As a non-limiting example, 30 timesteps with this “15,10,5” schedule can be used for 10 epochs. Although the samples are taken uniformly inside a given segment, each segment has a different number of steps, making the whole schedule irregular (see FIG. 2B). The number of segments and the number of steps in each segment is chosen in this irregular schedule for the inverse problem setup based on computation time constraints while ensuring generalizability. Alternative schedules may be used for the same inverse problem, or for different inverse problems. For MRI reconstruction applications, a noise schedule that provides more frequent sampling at lower noise levels where high-frequency details are recovered, which is advantageous for preserving fine anatomical structures in MRI images, can be implemented. As a non-limiting example, a “17, 5, 3” schedule can be used, which allocates 17 steps to the first segment, 5 steps to the second segment, and 3 steps to the third segment, resulting in 25 total sampling steps.

In some implementations, deterministic sampling schemes can be used, such as denoising diffusion implicit models (DDIM), to sample from a pre-trained DDPM model. The forward process for DDIM can be expressed as:

$${q}_{σ} ( {x}_{t} \vert {x}_{t - 1} , {x}_{0} ) = \frac{{q}_{σ} ( {x}_{t - 1} \vert {x}_{t} , {x}_{0} ) \cdot {q}_{σ} ( {x}_{t} \vert {x}_{0} )}{{q}_{σ} ( {x}_{t - 1} \vert {x}_{0} )} .$$

As can be seen, each xₜ is not solely dependent on xₜ₋₁ but is also dependent on x₀, rendering the forward process non-Markovian. Given a noisy observation xₜ, the reverse process involves initially predicting the corresponding denoised x₀ via Tweedie's formula as follows:

$${\hat{x}}_{0} = \frac{{x}_{t} - \sqrt{1 - {\overline{α}}_{t}} \cdot {ϵ}_{θ} ( {x}_{t} , t )}{\sqrt{{\overline{α}}_{t}}} .$$

Using this estimate, one can generate a sample xₜ₋₁ from a sample xₜ via:

$${x}_{t - 1} = \sqrt{{\overline{α}}_{t - 1}} {\hat{x}}_{0} + \sqrt{1 - {\overline{α}}_{t - 1} - {σ}_{t}^{2}} \cdot {ϵ}_{θ} ( {x}_{t} , t ) + {σ}_{t} z ,$$

where

$${σ}_{t} = η \cdot \sqrt{\frac{( 1 - {\overline{α}}_{t - 1} )}{( 1 - {\overline{α}}_{t} )} \cdot ( 1 - \frac{{\overline{α}}_{t}}{{\overline{α}}_{t - 1}} )}$$

and z~ [symbol] (0,I). When σₜ=0, the sampling process becomes deterministic. The parameter η∈[0,1] controls the level of stochasticity, where setting η=0 yields a purely deterministic process, whereas η=1 corresponds to DDPM sampling.

### Example: Natural Image Restoration

In an example study, a comprehensive evaluation of the disclosed methods was conducted by examining the performance of the disclosed methods through both qualitative and quantitative analyses using FFHQ and ImageNet datasets with size 256×256×3. Pre-trained unconditional diffusion models trained on FFHQ and ImageNet were used without retraining. For the experiments, 1000 images from FFHQ and ImageNet validation sets were sampled. All images underwent pre-processing where they were normalized to the range [0,1]. During all the evaluations, a Gaussian noise with σ=0.05 was used. For the orthogonal wavelet transform, Daubechies 4 wavelet was utilized. For the quantitative evaluations, 30 sampling steps were employed with a schedule of “15,10,5”, and 10 epochs for fine-tuning, resulting in a total of 300 neural function evaluations (NFEs). The schedule used in this example study was simple and sampled more frequently at the lower noise levels. Alternative sample schedules can also be used.

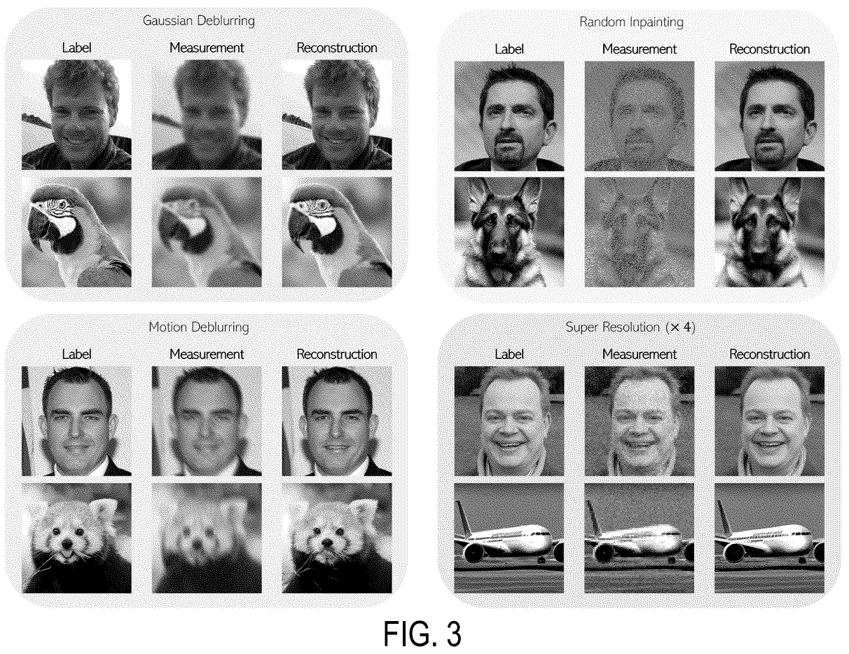

The following tasks for linear inverse problems were evaluated in this study: (1) Gaussian deblurring, (2) inpainting, (3) motion deblurring, and (4) super-resolution. For Gaussian deblurring, a kernel of size 61×61 with a standard deviation σ=3.0 was considered. For inpainting, two different scenarios were considered wherein 70% of an image was masked out or a 128×128 box region of the image was masked out, applied uniformly across all three channels. For motion blur, a blur kernel was generated with 61×61 kernel size and 0.5 intensity. For super-resolution, a bicubic downsampling was considered. All measurements were obtained through applying the forward model to a ground truth image. FIG. 3 shows representative results of the using methods described in the present disclosure for these four tasks.

The disclosed methods were compared with score-SDE, manifold constrained gradients (MCG), denoising diffusion restoration models (DDRM), diffusion posterior sampling (DPS), and pseudo-inverse guided diffusion models (ΠGDM). The methods that iteratively applied projections onto convex sets (POCS) were referred to as score-SDE. All methods were implemented using their respective public repositories.

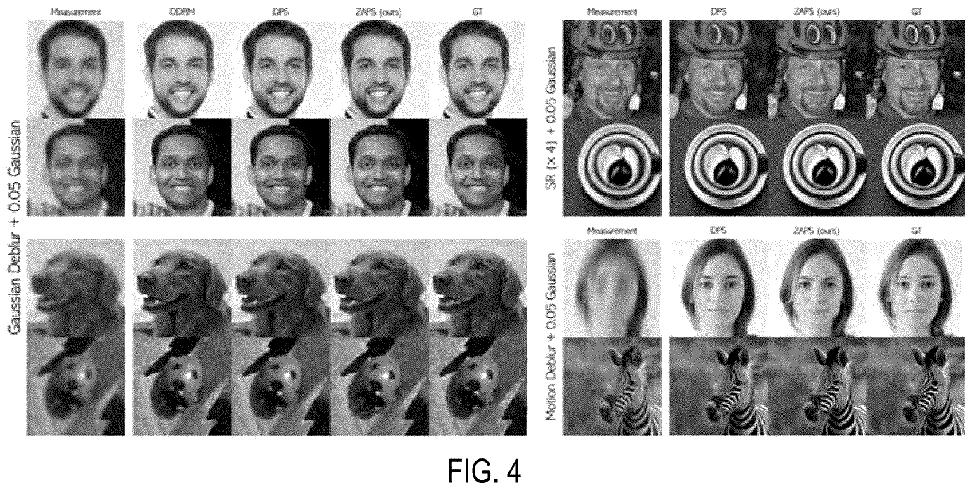

The disclosed methods were evaluated quantitatively by using Learned Perceptual Image Patch Similarity (LPIPS) distance, structural similarity index (SSIM), and peak signal-to-noise-ratio (PSNR) metrics. Representative results in FIG. 4 show that DDRM yielded blurry results in the Gaussian deblurring task. In contrast, DPS achieved notable sharpness across diverse inverse problem tasks, while ZAPS managed to attain comparable sharpness while exhibiting a higher similarity to the ground truth, all within a third of the total NFEs.

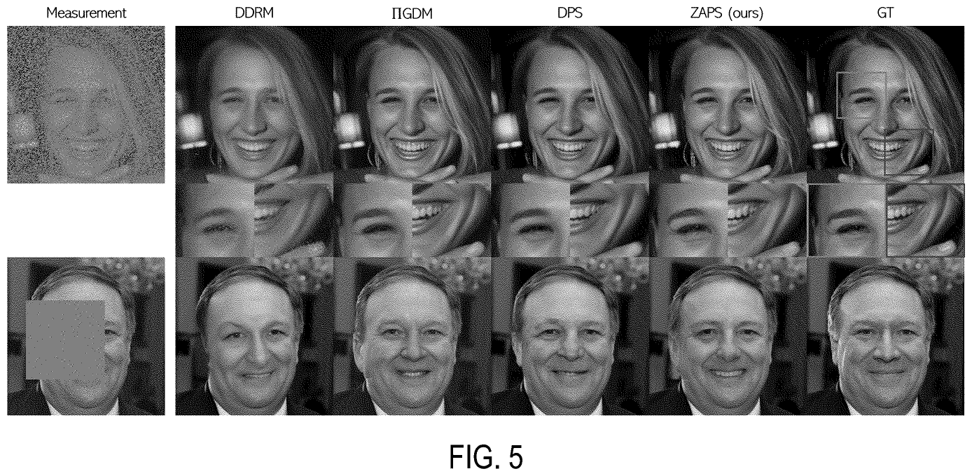

Representative inpainting results shown in FIG. 5 illustrate that ZAPS substantially improved upon DDRM, a method that used slightly fewer time steps (i.e., 20), and achieved comparable better similarity to the ground truth and sharpness compared to DPS, which used almost 33 times the number of steps. Similarly, when compared with ΠGDM, it can be seen that the disclosed ZAPS method gave comparable results even though 3-4 times fewer number of steps were used in the ZAPS method. The zoomed insets highlight subtle improvement afforded by the ZAPS method as compared to the DPS and ΠGDM methods.

Tables 1 and 2 below show the three quantitative metrics for all methods, while Table 3 illustrates their computational complexity. ZAPS outperformed Score-SDE, MCG, and the baseline DPS, in computational complexity and quantitative performance, yielding faster and improved reconstructions. Although DDRM and ΠGDM surpassed ZAPS in terms of computational complexity, ZAPS outperformed both methods quantitatively in terms of all three metrics. Furthermore, ΠGDM could not be implemented reliably for several linear inverse problems related to deblurring. It is also noted that the parameters in ZAPS are adaptive, meaning one can reach the same computational complexity by adjusting total epochs or steps, in trade-off for a slight decrease in performance.

TABLE 1
Quantitative results for Gaussian deblurring and random inpainting
(70%) on FFHQ dataset. Best results are given in bold, second-
best results are being underlined. A baseline is omitted if it
is not implemented for the given inverse problem task.

| | Gaussian Deblurring | | | Random Inpainting | | |
|---|---|---|---|---|---|---|
| Method | LPIPS↓ | SSIM↑ | PSNR↑ | LPIPS↓ | SSIM↑ | PSNR↑ |
| DPS | 0.128 | 0.718 | 25.20 | 0.104 | 0.811 | 28.03 |
| MCG | 0.558 | 0.509 | 15.12 | 0.145 | 0.754 | 25.33 |
| ΠGDM | — | — | — | 0.086 | 0.842 | 26.62 |
| DDRM | 0.183 | 0.702 | 24.42 | 0.198 | 0.741 | 25.17 |
| Score-SDE | 0.571 | 0.496 | 15.17 | 0.224 | 0.718 | 24.44 |
| ZAPS | 0.121 | 0.757 | 26.06 | 0.075 | 0.813 | 27.79 |

TABLE 2
Quantitative results for motion deblurring and super-resolution
(×4) on FFHQ dataset. Best results are given in bold, second-
best results are being underlined. A baseline is omitted if
it is not implemented for the given inverse problem task.

| | Motion Deblurring | | | Super Resolution (×4) | | |
|---|---|---|---|---|---|---|
| Method | LPIPS↓ | SSIM↑ | PSNR↑ | LPIPS↓ | SSIM↑ | PSNR↑ |
| DPS | 0.143 | 0.704 | 24.03 | 0.168 | 0.719 | 23.86 |
| MCG | 0.565 | 0.497 | 15.10 | 0.229 | 0.623 | 20.74 |
| ΠGDM | — | — | — | 0.131 | 0.760 | 24.48 |
| DDRM | — | — | — | 0.175 | 0.711 | 24.55 |
| Score-SDE | 0.546 | 0.488 | 15.02 | 0.257 | 0.609 | 19.13 |
| ZAPS | 0.141 | 0.709 | 24.16 | 0.104 | 0.768 | 26.63 |

TABLE 3
Computational costs of methods in terms
of NFEs and wall-clock time (WCT)

| | | | | | Score- | |
|---|---|---|---|---|---|---|
| | DPS | MCG | ΠGDM | DDRM | SDE | ZAPS |
| Total NFEs | 1000 | 1000 | 100 | 20 | 1000 | 300 |
| WCT (s) | 47.25 | 48.83 | 4.53 | 2.12 | 23.47 | 14.71 |

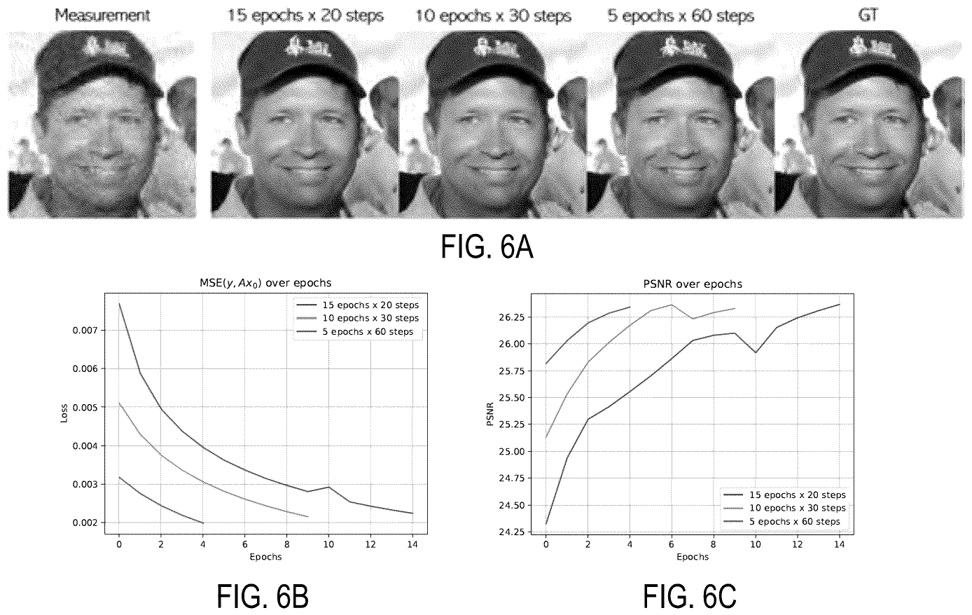

Two ablation studies were also conducted to investigate aspects of the ZAPS method performance. The first ablation study involved comparing combinations of different timesteps and epochs with a fixed NFE budget, providing a nuanced exploration into the influence of specific combinations on the model's behavior. Specifically, the reconstruction capabilities of the model were qualitatively and quantitatively explored by varying the length of model timesteps, T∈{20,30,60}. For a fixed NFE budget of 300, these corresponded to 15, 10, and 5 epochs for zero-shot fine-tuning, respectively. The sweeps were also fine-tuned accordingly to get the best out of each combination. FIG. 6A shows that while the final image qualities are similar, sharpness increases slightly as the number of steps increases. FIGS. 6B and 6C show the corresponding loss and PSNR curves for each combination, respectively. Notably, all the estimates are similar, though sharpness improves slightly as the number of steps increases. However, the trade-off for choosing a high number of steps is the low number of epochs. Especially for cases, where the measurement system or noise level changes, this makes fine-tuning susceptible to initialization of the hyperparameters as it is more difficult to converge to a good solution in ~5 epochs. Thus, for improved generalizability and robustness, a total number of 30 steps and 10 epochs was used for database testing.

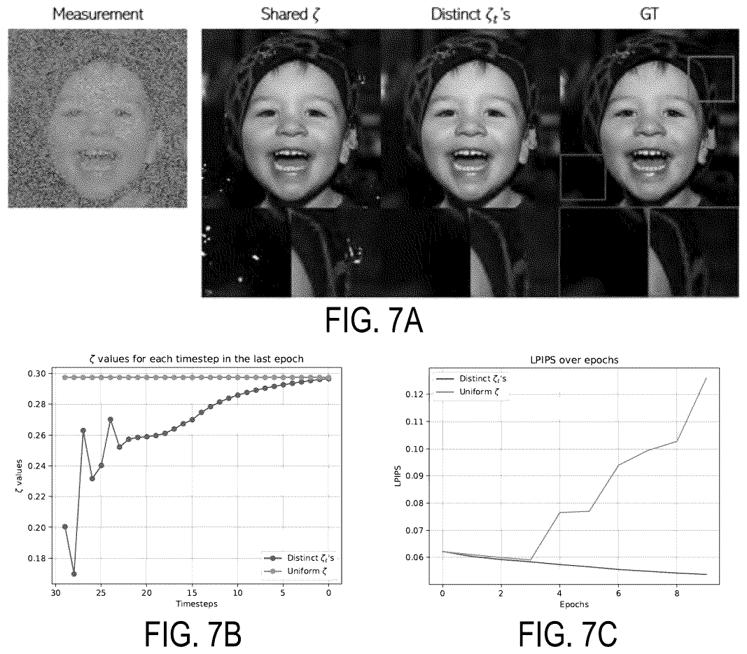

The second ablation study explored the impact of selecting a shared weight ζ for every step versus using distinct weights ζₜ for each timestep. FIG. 7A shows that the shared ζ approach leads to artifacts that are highlighted in the zoomed-in insets. Furthermore, FIG. 7B shows that the shared approach is susceptible to the goodness of the initialization, while the adaptive ζₜ weights are able to recover from arbitrary initializations. FIG. 7C further shows that the shared approach can be prone to overfitting. Thus, the proposed approach with adaptive ζₜ log-likelihood weights is advantageous.

Thus, a framework referred to as zero-shot approximate diffusion posterior sampling (ZAPS), which harnesses zero-shot learning for dynamic automated hyperparameter tuning during the inference phase to enhance the reconstruction quality of solving linear noisy inverse problems using diffusion models, has been provided. In particular, it has been demonstrated that learning the log-likelihood weights facilitates the usage of more complex and irregular noise schedules, whose feasibility for inverse problems. These irregular noise schedules enable high quality reconstructions with 20-50× fewer timesteps. When the number of epochs for fine-tuning is also considered, the disclosed methods result in a speed boost of approximately 3× compared to state-of-the-art methods like DPS.

### Example: MRI Reconstruction

In another example study, the ZADS framework was evaluated for accelerated MRI reconstruction using the NYU fastMRI multi-coil knee dataset. The dataset contained coronal proton density (cor PD) and coronal proton density with fat suppression (cor PD-FS) scans, acquired at a matrix size of 320×320 using 15 coils. Retrospective uniform undersampling was applied to both datasets using an acceleration factor of R=4, retaining 24 central k-space lines. The experiments focused on equidistant sampling schemes, which are standard in clinical MRI and produce structured aliasing artifacts that are considerably harder to suppress than the noise-like artifacts introduced by random sampling.

A pretrained unconditional diffusion model trained on FastMRI knee images was used without any additional retraining. For evaluation, 100 central slices from 10 subjects per dataset were selected, resulting in a total of 200 slices. Undersampled k-space data were generated by applying the sampling mask Ω to the noisy fully-sampled measurements. For quantitative evaluation, 25 sampling steps following a “17,5,3” schedule were used, with 10 fine-tuning epochs, resulting in a total of 250 NFEs. The sampling ratio ρ=|Λ|/|Ω| was set to 0.4.

The ZADS method was compared against conventional [symbol] ₁-wavelet compressed sensing, as well as two diffusion-based baselines: DPS and DDS. Both diffusion methods were implemented using their official public repositories. To ensure a fair comparison, all methods used the same pretrained unconditional diffusion model and employed DDIM sampling with η=0.85. 15 CG iterations were used for both DDS and ZADS.

The reconstruction comparisons on the coronal PD and PD-FS datasets demonstrated that the [symbol] ₁-wavelet method produced visibly inferior reconstructions, failing to recover fine structures in both contrasts. While DPS benefited from a large number of sampling steps, it produced overly smoothed outputs and exhibited notable residual artifacts, particularly in the PD-FS case. The DDS (25) results further highlighted the importance of combining irregular sampling schedules with adaptive fidelity weight tuning. Despite using the same number of sampling steps as ZADS, DDS exhibited visible artifacts, whereas ZADS produced cleaner reconstructions, demonstrating the benefits of test-time adaptation.

The importance of adapting fidelity weights to the underlying SNR became evident from the DDS (250) results. This configuration performed reasonably on the high-SNR coronal PD dataset; however, it also amplified noise on the low-SNR PD-FS dataset, indicating that a fixed regularization weight does not generalize effectively across different noise levels. ZADS achieved the most effective artifact and noise suppression across both datasets.

Quantitative results demonstrated that ZADS consistently outperformed both traditional compressed sensing and recent diffusion-based methods. For the coronal PD dataset, ZADS achieved a PSNR of 36.32 dB and SSIM of 0.938, compared to DPS (1000 steps) with 34.90 dB PSNR and 0.891 SSIM, and DDS (250 steps) with 34.93 dB PSNR and 0.899 SSIM. For the coronal PD-FS dataset, ZADS achieved 32.48 dB PSNR and 0.818 SSIM, outperforming all baseline methods.

An ablation study demonstrated that within the ZADS framework, irregular sampling schedules capture fine structural details more effectively than uniform schedules, leading to visibly sharper reconstructions. This validates the importance of the irregular noise schedule in combination with adaptive fidelity weight tuning for MRI reconstruction applications.

Thus, the frameworks referred to as ZAPS and ZADS, which harness zero-shot learning for dynamic automated hyperparameter tuning during the inference phase to enhance the reconstruction quality of solving linear noisy inverse problems using diffusion models, have been provided. In particular, it has been demonstrated that learning the log-likelihood weights facilitates the usage of more complex and irregular noise schedules, whose feasibility for inverse problems. These irregular noise schedules enable high quality reconstructions with 20-50× fewer timesteps. When the number of epochs for fine-tuning is also considered, the disclosed methods result in a speed boost of approximately 3× compared to state-of-the-art methods like DPS. The ZADS framework, with its SSDU-based self-supervised loss and CG-based data consistency updates, is particularly well-suited for MRI reconstruction applications where fully-sampled reference data may not be available and where the measurement conditions vary across acquisition settings.

### Example: Dataset-Level Adaptation for MRI Reconstruction

As described above, diffusion models define a generative process by introducing a sequence of latent variables that interpolate between structured data and pure noise. Rather than modeling data directly, these models construct a tractable family of intermediate distributions that allow sampling from a complex target distribution through iterative refinement.

A neural network, \hat{∈}ₜ=∈_{θ}(×ₜ, t), can be trained to estimate the noise component associated with each latent variable. This estimator enables recovery of an approximation to the underlying clean image at any timestep via:

$${\hat{x}}_{0 \vert t} = \frac{{x}_{t} - \sqrt{1 - {\overline{α}}_{t}} {\hat{ϵ}}_{t}}{\sqrt{{\overline{α}}_{t}}} ,$$

which serves as a sufficient statistic for reverse-time generation.

Sampling proceeds by constructing a sequence of reverse-time updates that map xₜ to xₜ₋₁. In the DDIM framework, this mapping is expressed as a deterministic or partially stochastic transformation that preserves the marginal consistency of the diffusion process while allowing flexible control over the sampling trajectory. Specifically, the update rule is given by,

$${x}_{t - 1} = \sqrt{{\overline{α}}_{t - 1}} {\hat{x}}_{0 \vert t} + \sqrt{1 - {\overline{α}}_{t - 1} - {{σ}_{t} ( η )}^{2}} {\hat{ϵ}}_{t} + {σ}_{t} ( η ) z , {=}^{Δ} \sqrt{{\overline{α}}_{t - 1}} {\hat{x}}_{0 \vert t} + {\tilde{ω}}_{t} ,$$

where z~ [symbol] (0,I) and η∈[0,1] determines the amount of injected stochasticity. When η=0, the sampling trajectory is fully deterministic, yielding a single implicit generative path. Larger values of η introduce randomness into the update, progressively recovering the stochastic behavior of the original diffusion process.

In a non-limiting example implementation of the database-level adaptation methods described in the present disclosure, the accelerated MRI reconstruction problem is considered, where the goal is to recover a clean image x from undersampled k-space measurements. The measurement model is given by:

$${y}_{Ω} = {E}_{Ω} x + n ,$$

where y_{Ω} denotes the acquired k-space samples indexed by the undersampling mask Ω, E_{Ω} is the MRI encoding operator incorporating Fourier transforms, coil sensitivity maps, and sampling, and n represents measurement noise. Diffusion-based inverse solvers aim to recover x by combining a pretrained generative diffusion prior with explicit data consistency updates that enforce agreement with the acquired k-space measurements.

Let [symbol] _{θ} denote a pretrained diffusion or score-based generative model with fixed parameters θ, which implicitly defines a prior distribution p_{θ}(×) over fully sampled MR images. A Bayesian formulation under additive white Gaussian noise (AWGN) is adopted, where the MRI forward model is expressed as,

$${y}_{Ω} = {E}_{Ω} x + n , n ∼ 𝒩 ( 0 , {σ}^{2} I ) .$$

Under this assumption, the posterior distribution over the image takes the form:

$$p ( x \vert {y}_{Ω} ) ∝ p ( {y}_{Ω} \vert x ) {p}_{θ} ( x ) ,$$

where the likelihood term p(y_{Ω}|x) induces a quadratic data fidelity penalty defined in k-space.

During reconstruction, the diffusion sampler performs iterative posterior refinement by combining the learned score of the image prior with data consistency updates derived from the MRI log-likelihood. A scalar or timestep-dependent modulation parameter (governs the relative influence of the data fidelity term with respect to the generative prior at each denoising step, thereby controlling the strength of posterior conditioning throughout the sampling trajectory.

In existing diffusion-based MRI reconstruction methods, the fidelity modulation parameter (is typically chosen using heuristics or optimized independently for each test slice. While such instance-specific tuning can adapt to local noise levels or sampling patterns, additional computational overhead at inference time can be introduced and inconsistent behavior across slices may result due to optimization noise or limited measurements. Moreover, per-sample optimization fails to exploit shared structure across an MRI dataset, despite the fact that effective posterior conditioning strategies are often governed by common acquisition protocols, undersampling patterns, and noise characteristics. These limitations motivate a shift away from per-slice optimization toward a learned, database-level approach that amortizes posterior adaptation while improving robustness and generalization.

To address these challenges, an auxiliary network g^{φ}(⋅), parameterized by p and implemented as a lightweight model (e.g., an MLP) is used to predict data fidelity modulation parameters used during diffusion-based MRI reconstruction. Rather than relying on explicitly provided noise estimates or acquisition metadata, the auxiliary network takes as input a zero-filled (ZF) reconstruction obtained by applying the adjoint MRI operator

$${E}_{Ω}^{H}$$

to the undersampled k-space measurements. This ZF image implicitly captures key characteristics of the inverse problem, including the undersampling pattern, acceleration factor, coil geometry, and effective signal-to-noise ratio.

Given a ZF reconstruction

$${x}_{ZF} = {E}_{Ω}^{H} {y}_{Ω} ,$$

the auxiliary network uses this image as its conditioning input and outputs a set of modulation parameters:

$$\{ {ζ}_{i} \} = {g}_{ϕ} ( {x}_{ZF} ) ,$$

which control the strength of data fidelity enforcement at different stages of the diffusion sampling process.

The predicted parameters are injected directly into the diffusion-based reconstruction pipeline, replacing manually selected or iteratively optimized fidelity settings. Importantly, the generative diffusion model [symbol] remains entirely frozen throughout both training and inference, ensuring that the learned adaptation operates solely through the auxiliary network while preserving the pretrained image prior.

Training is performed over a database of paired undersampled k-space measurements and reference images

$${\{ ( {y}_{Ω}^{j} , {x}_{ref}^{j} ) \}}_{j = 1}^{N} ,$$

where j indexes the training samples and N denotes the number of fully sampled images available in the training database. For each training example, a zero-filled reconstruction

$${x}_{ZF}^{j} = {E}_{Ω}^{H} {y}_{Ω}^{j}$$

is first computed and used as input to the auxiliary network g_{φ}(⋅). The network predicts a set of data fidelity modulation parameters, which are then injected into a fixed diffusion-based MRI reconstruction pipeline to produce a reconstructed image

$${x}_{0}^{j} .$$

In its simplest form, a supervised reconstruction loss is computed by comparing the reconstructed image to the fully sampled reference:

$$ℒ ( {x}_{0}^{j} , {x}_{ref}^{j} ) ,$$

and gradients are backpropagated exclusively through the auxiliary network, while all parameters of the pretrained diffusion model remain frozen. The auxiliary network parameters are learned by minimizing the empirical risk over the training database:

$${min}_{ϕ} \frac{1}{N} {\sum }_{j = 1}^{N} ℒ ( {x}_{0}^{j} ( {g}_{ϕ} ( {x}_{ZF}^{j} ) ) , {x}_{ref}^{j} ) .$$

Similarly a self-supervised loss can also be used if reference images are unavailable. Here the notation

$${x}_{0}^{j} ( {g}_{ϕ} ( {x}_{ZF}^{j} ) )$$

denotes the output of the diffusion inverse problem solver that starts sampling from a noise instance using the pretrained score network D_{θ}, while ensuring data fidelity via weights given by {ζᵢ}=g_{φ}(×_{ZF}).

By decoupling learning from the generative prior, the auxiliary network learns dataset-level data fidelity control strategies that generalize across subjects, sampling patterns, and noise conditions, while preserving the pretrained diffusion model as a fixed image prior.

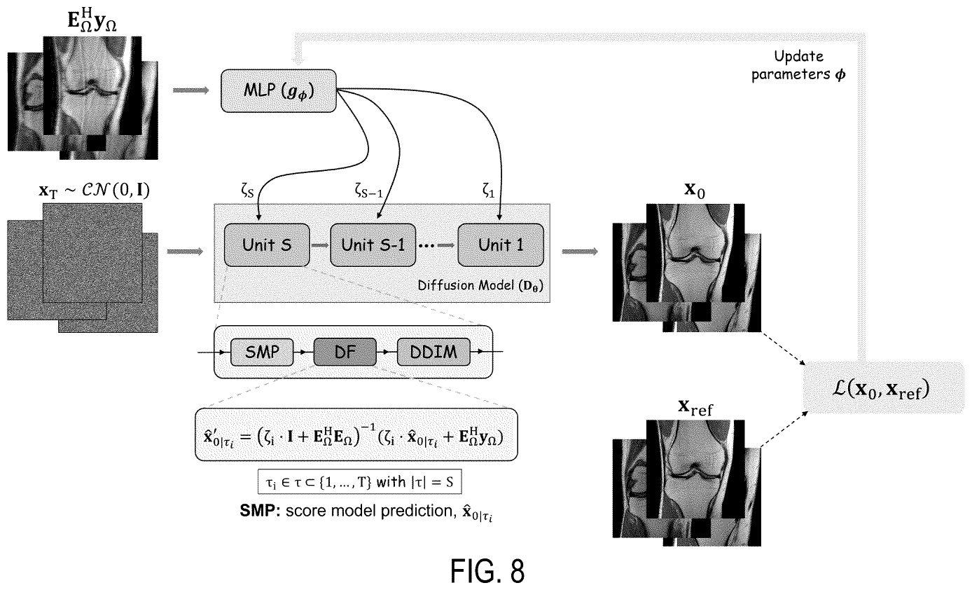

At inference time, the trained auxiliary network predicts the required modulation parameters in a single forward pass from the zero-filled input. These parameters are directly applied within the diffusion-based reconstruction process, eliminating the need for per-slice optimization or heuristic tuning and enabling fast and adaptive MRI reconstruction with minimal computational overhead. An overview of the proposed database-level data fidelity control framework and its integration with the diffusion-based MRI reconstruction pipeline is illustrated in FIG. 8.

An advantage of diffusion-based generative models is their scalability and forward-operator agnostic nature, allowing a single pretrained prior to be reused across diverse inverse problems. Retraining or modifying the diffusion prior would compromise this advantage; therefore, in this non-limiting example implementation of the database-level adaptation, the diffusion model is deliberately kept fixed and learning is confined to a lightweight auxiliary network that adaptively controls data fidelity. This design not only preserves the expressive power and generalization capability of the pretrained diffusion prior, but also results in a simpler and more stable training procedure by avoiding the joint optimization of large reconstruction networks.

### Example System

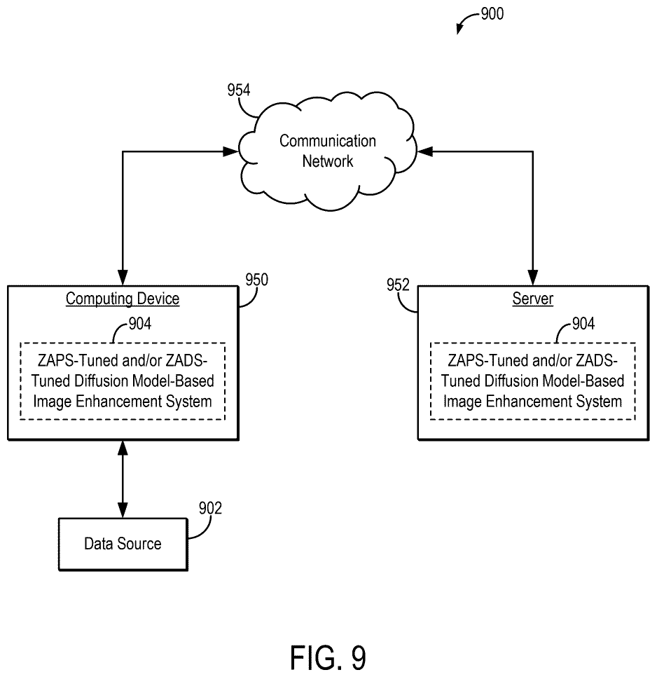

FIG. 9 shows an example of a system 900 for constructing, tuning, and implementing a diffusion model (e.g., a DDPM) to solve an inverse problem for an image enhancement or reconstruction task in accordance with some examples described in the present disclosure. As shown in FIG. 9, a computing device 950 can receive one or more types of data (e.g., image data, k-space data, MRI measurement data) from data source 902. In some examples, computing device 950 can execute at least a portion of a zero-shot approximate diffusion posterior sampling (ZAPS) tuned and/or zero-shot adaptive diffusion sampling (ZADS) diffusion model-based image enhancement system 904 to enhance images from data received from the data source 902, and/or to reconstruct images from undersampled measurement data received from the data source 802, such as undersampled k-space data from an MRI acquisition. In some examples, the computing device 950 can also execute a database-level adaptation framework that utilizes an auxiliary network to predict data fidelity modulation parameters from zero-filled reconstructions, enabling learned dataset-level data fidelity control without per-instance optimization.

Additionally or alternatively, in some examples, the computing device 950 can communicate information about data received from the data source 902 to a server 952 over a communication network 954, which can execute at least a portion of the ZAPS-tuned and/or ZADS-tuned diffusion model-based image enhancement system 904, including database-level adaptation using a trained auxiliary network. In such examples, the server 952 can return information to the computing device 950 (and/or any other suitable computing device) indicative of an output of the ZAPS-tuned and/or ZADS-tuned diffusion model-based image enhancement system 904, including reconstructed images generated using predicted data fidelity weights from the auxiliary network.

In some examples, computing device 950 and/or server 952 can be any suitable computing device or combination of devices, such as a desktop computer, a laptop computer, a smartphone, a tablet computer, a wearable computer, a server computer, a virtual machine being executed by a physical computing device, and so on. The computing device 950 and/or server 952 can also reconstruct images from the data, including performing MRI reconstruction from undersampled k-space data using the ZADS framework. In some examples, the computing device 950 and/or server 952 can implement database-level adaptation by executing a trained auxiliary network that predicts timestep-dependent data fidelity weights in a single forward pass from a zero-filled input, eliminating the need for per-slice optimization or heuristic tuning while keeping the pretrained diffusion model entirely frozen.

In some examples, data source 902 can be any suitable source of data (e.g., measurement data, images reconstructed from measurement data, processed image data, k-space data, multi-coil data), such as a medical imaging system (e.g., an MRI system), another computing device (e.g., a server storing measurement data, images reconstructed from measurement data, processed image data), and so on. In some examples, data source 902 can be local to computing device 950. For example, data source 902 can be incorporated with computing device 950 (e.g., computing device 950 can be configured as part of a device for measuring, recording, estimating, acquiring, or otherwise collecting or storing data). As another example, data source 902 can be connected to computing device 950 by a cable, a direct wireless link, and so on. Additionally or alternatively, in some examples, data source 902 can be located locally and/or remotely from computing device 950, and can communicate data to computing device 950 (and/or server 952) via a communication network (e.g., communication network 954).

In some examples, communication network 954 can be any suitable communication network or combination of communication networks. For example, communication network 954 can include a Wi-Fi network (which can include one or more wireless routers, one or more switches, etc.), a peer-to-peer network (e.g., a Bluetooth network), a cellular network (e.g., a 3G network, a 4G network, etc., complying with any suitable standard, such as CDMA, GSM, LTE, LTE Advanced, WiMAX, etc.), other types of wireless network, a wired network, and so on. In some examples, communication network 954 can be a local area network, a wide area network, a public network (e.g., the Internet), a private or semi-private network (e.g., a corporate or university intranet), any other suitable type of network, or any suitable combination of networks. Communications links shown in FIG. 9 can each be any suitable communications link or combination of communications links, such as wired links, fiber optic links, Wi-Fi links, Bluetooth links, cellular links, and so on.

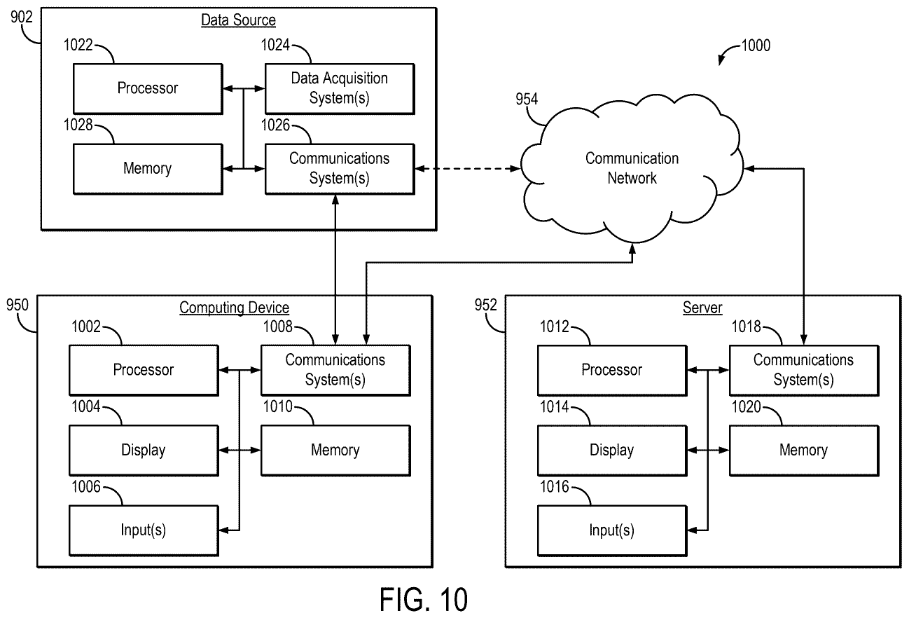

Referring now to FIG. 10, an example of hardware 1000 that can be used to implement data source 902, computing device 950, and server 952 in accordance with some examples of the systems and methods described in the present disclosure is shown.

As shown in FIG. 10, in some examples, computing device 950 can include a processor 1002, a display 1004, one or more inputs 1006, one or more communication systems 1008, and/or memory 1010. In some examples, processor 1002 can be any suitable hardware processor or combination of processors, such as a central processing unit (CPU), a graphics processing unit (GPU), and so on. In some examples, display 1004 can include any suitable display devices, such as a liquid crystal display (LCD) screen, a light-emitting diode (LED) display, an organic LED (OLED) display, an electrophoretic display (e.g., an “e-ink” display), a computer monitor, a touchscreen, a television, and so on. In some examples, inputs 1006 can include any suitable input devices and/or sensors that can be used to receive user input, such as a keyboard, a mouse, a touchscreen, a microphone, and so on.

In some examples, communications systems 1008 can include any suitable hardware, firmware, and/or software for communicating information over communication network 954 and/or any other suitable communication networks. For example, communications systems 1008 can include one or more transceivers, one or more communication chips and/or chip sets, and so on. In a more particular example, communications systems 1008 can include hardware, firmware, and/or software that can be used to establish a Wi-Fi connection, a Bluetooth connection, a cellular connection, an Ethernet connection, and so on.

In some examples, memory 1010 can include any suitable storage device or devices that can be used to store instructions, values, data, or the like, that can be used, for example, by processor 1002 to present content using display 1004, to communicate with server 952 via communications system(s) 1008, and so on. Memory 1010 can include any suitable volatile memory, non-volatile memory, storage, or any suitable combination thereof. For example, memory 1010 can include random-access memory (RAM), read-only memory (ROM), electrically programmable ROM (EPROM), electrically erasable ROM (EEPROM), other forms of volatile memory, other forms of non-volatile memory, one or more forms of semi-volatile memory, one or more flash drives, one or more hard disks, one or more solid state drives, one or more optical drives, and so on. In some examples, memory 1010 can have encoded thereon, or otherwise stored therein, a computer program for controlling operation of computing device 950. In such examples, processor 1002 can execute at least a portion of the computer program to present content (e.g., images, user interfaces, graphics, tables), receive content from server 952, transmit information to server 952, and so on. For example, the processor 1002 and the memory 1010 can be configured to perform the methods described herein, including the ZAPS and ZADS frameworks for tuning diffusion models, performing image processing tasks, and reconstructing images from undersampled data.

In some examples, server 952 can include a processor 1012, a display 1014, one or more inputs 1016, one or more communications systems 1018, and/or memory 1020. In some examples, processor 1012 can be any suitable hardware processor or combination of processors, such as a CPU, a GPU, and so on. In some examples, display 1014 can include any suitable display devices, such as an LCD screen, LED display, OLED display, electrophoretic display, a computer monitor, a touchscreen, a television, and so on. In some examples, inputs 1016 can include any suitable input devices and/or sensors that can be used to receive user input, such as a keyboard, a mouse, a touchscreen, a microphone, and so on.

In some examples, communications systems 1018 can include any suitable hardware, firmware, and/or software for communicating information over communication network 954 and/or any other suitable communication networks. For example, communications systems 1018 can include one or more transceivers, one or more communication chips and/or chip sets, and so on. In a more particular example, communications systems 1018 can include hardware, firmware, and/or software that can be used to establish a Wi-Fi connection, a Bluetooth connection, a cellular connection, an Ethernet connection, and so on.

In some examples, memory 1020 can include any suitable storage device or devices that can be used to store instructions, values, data, or the like, that can be used, for example, by processor 1012 to present content using display 1014, to communicate with one or more computing devices 950, and so on. Memory 1020 can include any suitable volatile memory, non-volatile memory, storage, or any suitable combination thereof. For example, memory 1020 can include RAM, ROM, EPROM, EEPROM, other types of volatile memory, other types of non-volatile memory, one or more types of semi-volatile memory, one or more flash drives, one or more hard disks, one or more solid state drives, one or more optical drives, and so on. In some examples, memory 1020 can have encoded thereon a server program for controlling operation of server 952. In such examples, processor 1012 can execute at least a portion of the server program to transmit information and/or content (e.g., data, images, a user interface) to one or more computing devices 950, receive information and/or content from one or more computing devices 950, receive instructions from one or more devices (e.g., a personal computer, a laptop computer, a tablet computer, a smartphone), and so on. In some embodiments, memory 920 can store pretrained unconditional diffusion models that can be used by the ZADS framework without retraining, as well as timestep-dependent fidelity weights that are optimized during test-time adaptation.

In some examples, the server 952 is configured to perform the methods described in the present disclosure. For example, the processor 1012 and memory 1020 can be configured to perform the methods described herein, including the ZAPS and ZADS frameworks for tuning diffusion models, performing image processing tasks, and reconstructing images from undersampled data.

In some examples, data source 902 can include a processor 1022, one or more data acquisition systems 1024, one or more communications systems 1026, and/or memory 1028. In some examples, processor 1022 can be any suitable hardware processor or combination of processors, such as a CPU, a GPU, and so on. In some examples, the one or more data acquisition systems 1024 are generally configured to acquire data, images, or both, and can include a medical imaging system, such as an MRI system. Additionally or alternatively, in some examples, the one or more data acquisition systems 1024 can include any suitable hardware, firmware, and/or software for coupling to and/or controlling operations of a medical imaging system. In some examples, one or more portions of the data acquisition system(s) 1024 can be removable and/or replaceable. In some embodiments, the data acquisition systems 924 can be configured to acquire undersampled k-space data using equidistant or other sampling patterns, which can then be processed using the ZADS framework for image reconstruction.

Note that, although not shown, data source 902 can include any suitable inputs and/or outputs. For example, data source 902 can include input devices and/or sensors that can be used to receive user input, such as a keyboard, a mouse, a touchscreen, a microphone, a trackpad, a trackball, and so on. As another example, data source 902 can include any suitable display devices, such as an LCD screen, an LED display, an OLED display, an electrophoretic display, a computer monitor, a touchscreen, a television, etc., one or more speakers, and so on.

In some examples, communications systems 1026 can include any suitable hardware, firmware, and/or software for communicating information to computing device 950 (and, in some examples, over communication network 954 and/or any other suitable communication networks). For example, communications systems 1026 can include one or more transceivers, one or more communication chips and/or chip sets, and so on. In a more particular example, communications systems 1026 can include hardware, firmware, and/or software that can be used to establish a wired connection using any suitable port and/or communication standard (e.g., VGA, DVI video, USB, RS-232, etc.), Wi-Fi connection, a Bluetooth connection, a cellular connection, an Ethernet connection, and so on.

In some examples, memory 1028 can include any suitable storage device or devices that can be used to store instructions, values, data, or the like, that can be used, for example, by processor 1022 to control the one or more data acquisition systems 1024, and/or receive data from the one or more data acquisition systems 1024; to generate images from data; present content (e.g., data, images, a user interface) using a display; communicate with one or more computing devices 950; and so on. Memory 1028 can include any suitable volatile memory, non-volatile memory, storage, or any suitable combination thereof. For example, memory 1028 can include RAM, ROM, EPROM, EEPROM, other types of volatile memory, other types of non-volatile memory, one or more types of semi-volatile memory, one or more flash drives, one or more hard disks, one or more solid state drives, one or more optical drives, and so on. In some examples, memory 1028 can have encoded thereon, or otherwise stored therein, a program for controlling operation of data source 902. In such examples, processor 1022 can execute at least a portion of the program to generate images, transmit information and/or content (e.g., data, images, a user interface) to one or more computing devices 950, receive information and/or content from one or more computing devices 950, receive instructions from one or more devices (e.g., a personal computer, a laptop computer, a tablet computer, a smartphone, etc.), and so on. In some embodiments, memory 928 can store k-space sampling patterns and masks used for SSDU-based index splitting in the ZADS framework, wherein the acquired k-space locations are divided into disjoint sets for data fidelity updates and fidelity weight tuning.

In some examples, any suitable computer-readable media can be used for storing instructions for performing the functions and/or processes described herein. For example, in some examples, computer-readable media can be transitory or non-transitory. For example, non-transitory computer-readable media can include media such as magnetic media (e.g., hard disks, floppy disks), optical media (e.g., compact discs, digital video discs, Blu-ray discs), semiconductor media (e.g., RAM, flash memory, EPROM, EEPROM), any suitable media that is not fleeting or devoid of any semblance of permanence during transmission, and/or any suitable tangible media. As another example, transitory computer-readable media can include signals on networks, in wires, conductors, optical fibers, circuits, or any suitable media that is fleeting and devoid of any semblance of permanence during transmission, and/or any suitable intangible media.

As used herein in the context of computer implementation, unless otherwise specified or limited, the terms “component,” “system,” “module,” “framework,” and the like are intended to encompass part or all of computer-related systems that include hardware, software, a combination of hardware and software, or software in execution. For example, a component may be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) may reside within a process or thread of execution, may be localized on one computer, may be distributed between two or more computers or other processor devices, or may be included within another component (or system, module, and so on).

In some implementations, devices or systems disclosed herein can be utilized or installed using methods embodying aspects of the disclosure. Correspondingly, description herein of particular features, capabilities, or intended purposes of a device or system is generally intended to inherently include disclosure of a method of using such features for the intended purposes, a method of implementing such capabilities, and a method of installing disclosed (or otherwise known) components to support these purposes or capabilities. Similarly, unless otherwise indicated or limited, discussion herein of any method of manufacturing or using a particular device or system, including installing the device or system, is intended to inherently include disclosure, as examples of the disclosure, of the utilized features and implemented capabilities of such device or system.

The present disclosure has described one or more preferred examples, and it should be appreciated that many equivalents, alternatives, variations, and modifications, aside from those expressly stated, are possible and within the scope of the invention.

1. A method for tuning a diffusion model for solving an inverse problem, the method comprising:
accessing a diffusion model with a computer system, wherein the diffusion model has been trained on training data to solve an inverse problem;
tuning the diffusion model with the computer system by learning data fidelity weights for the diffusion model using an unsupervised loss function and a sampling noise schedule; and
storing the tuned diffusion model with the computer system.

2. The method of claim 1, wherein the unsupervised loss function comprises a measurement-consistent loss.

3. The method of claim 1, wherein tuning the diffusion model comprises fixing a number of diffusion sampling steps and tuning the data fidelity weights end-to-end with the unsupervised loss function.

4. The method of claim 1, wherein the sampling noise schedule comprises irregular time steps.

5. The method of claim 4, wherein the irregular timesteps of the sampling noise schedule comprise heavier denoising steps early in the sampling noise schedule and smaller denoising steps later in the sampling noise schedule.

6. The method of claim 4, wherein the sampling noise schedule comprises uniformly spaced segments across the sampling noise schedule, wherein each uniformly spaced segment comprises a different number of timesteps such that the sampling noise schedule comprises the irregular timesteps as a whole.

7. The method of claim 6, wherein the uniformly spaced segments comprises three segments.

8. The method of claim 7, wherein a first one of the three segments includes 15 time steps, a second one of the three segments includes 10 time steps, and a third one of the three segments includes 5 time steps.

9. The method of claim 1, wherein the data fidelity weights are learned at each timestep of the sampling noise schedule.

10. The method of claim 1, wherein the sampling noise schedule implements a deterministic sampling scheme.

11. The method of claim 10, wherein the deterministic sampling scheme comprises a denoising diffusion implicit model (DDIM) that samples from the diffusion model.

12. The method of claim 1, wherein the diffusion model comprises a denoising diffusion probabilistic model (DDPM).

13. The method of claim 1, wherein the inverse problem comprises an image reconstruction task.

14. The method of claim 1, wherein the inverse problem comprises an image deblurring task.

15. The method of claim 1, wherein the inverse problem comprises a super-resolution task.

16. The method of claim 1, wherein the inverse problem comprises an image inpainting task.

17. The method of claim 1, wherein the data fidelity weights for the diffusion model comprise log-likelihood weights.

18. The method of claim 17, wherein learning the log-likelihood weights for the diffusion model comprises approximating a log-gradient of a prior to reduce memory requirements for the computer system.

19. The method of claim 18, wherein the log-gradient of the prior is approximated by approximating a Jacobian using wavelet-based signal processing.

20. The method of claim 1, wherein the inverse problem comprises a magnetic resonance imaging (MRI) reconstruction task.

21. The method of claim 1, wherein the unsupervised loss function comprises a self-supervised loss function computed on held-out measurements.

22. The method of claim 21, wherein tuning the diffusion model comprises:
dividing acquired measurement data into a first disjoint set for data consistency updates and a second disjoint set for supervision; and
computing the self-supervised loss function based on a discrepancy between predicted measurements and actual measurements over the second disjoint set.

23. A method for reconstructing an image from undersampled measurement data, the method comprising:
accessing undersampled measurement data with a computer system;
accessing a pretrained diffusion model with the computer system;
dividing the undersampled measurement data into a first subset for data consistency updates and a second subset for fidelity weight optimization;
reconstructing the image by iteratively performing diffusion sampling steps using an irregular noise schedule, wherein each diffusion sampling step comprises:
computing a denoised estimate using the pretrained diffusion model;
performing a data fidelity update using the first subset and a timestep-dependent data fidelity weight; and
performing a diffusion sampling update;
optimizing each timestep-dependent data fidelity weight using a self-supervised loss computed on the second subset; and
outputting the reconstructed image.

24. The method of claim 23, wherein the undersampled measurement data comprises undersampled k-space data from a magnetic resonance imaging acquisition.

25. A method for enhancing an image using database-level adapted data fidelity control, the method comprising:
accessing input image data with a computer system;
computing an input representation from the input image data;
predicting data fidelity modulation parameters using a trained auxiliary network based on the input representation, wherein the trained auxiliary network has been trained over a database of training samples;
generating an enhanced image using a pretrained diffusion model and the predicted data fidelity modulation parameters, wherein the pretrained diffusion model remains frozen during image enhancement; and
outputting the enhanced image.

26. The method of claim 25, wherein the input image data comprise undersampled k-space data from a magnetic resonance imaging acquisition and the enhanced image comprises a magnetic resonance image reconstructed from the undersampled k-space data.
